(19) United States
(12) Patent Application Publication
(10) Pub. No.: US 2024/0346389 A1
(43) Pub. Date: Oct. 17, 2024

(54) ENSEMBLE LEARNING MODEL FOR TIME-SERIES FORECASTING

(71) Applicant: DoorDash, Inc., San Francisco, CA (US)

(72) Inventors: Qiyun Pan, Mountain View, CA (US); Hanyu Yang, Jersey City, NJ (US); Ryan Scott Schork, San Francisco, CA (US); Swaroop Chitlur Haridas, San Ramon, CA (US)

(73) Assignee: DoorDash, Inc., San Francisco, CA (US)

(21) Appl. No.: 18/633,918

(22) Filed: Apr. 12, 2024

Related U.S. Application Data
(60) Provisional application No. 63/496,206, filed on Apr. 14, 2023.

(51) Int. Cl. G06N 20/20

(52) U.S. Cl. CPC G06N 20/20

(57) ABSTRACT

Methods and systems for time series forecasting using ensemble machine learning are disclosed. A computer system (distributed or otherwise) can instantiate, train, and use a plurality of machine learning models to generate time series forecasts. These can include both different types of machine learning models, as well as similar machine learning models that have different configurations. Embodiments of the present disclosure can use a novel modification of k-folds cross validation techniques that preserves the order of temporal data. Time series data can be partitioned into segments and folds and used to train and test the plurality of machine learning models. Forecasts produced by the trained machine learning models, along with historical time series data (or “actuals”) can be used to train an ensemble machine learning model to produce an ensemble forecast based on forecasts generated by the trained machine learning models.

### CROSS-REFERENCE TO RELATED APPLICATIONS

This application is non-provisional and claims the benefit of U.S. Provisional Patent Application No. 63/496,206, entitled “ENSEMBLE LEARNING MODEL FOR TIME-SERIES FORECASTING,” filed on Apr. 14, 2023, which is hereby incorporated by reference in its entirety for all purposes.

### BACKGROUND

Time series data generally comprises data in which data values or observations are associated with time values, timestamps, or indices, thereby enabling time series data values to be organized, displayed, and/or analyzed based on their chronological ordering. Most data that can be correlated or otherwise associated with time can comprise time series data or can be used to derive time series data. For example, outdoor temperatures or wind speeds can be periodically recorded to create a time series. As another example, bioinformatics data, e.g., corresponding to the health of a patient can be collected to form a time series, such as a patent's heartrate during a period of exercise or during a treatment period. The price of a stock over time, e.g., from a stock ticker, is yet another example of time series data.

Forecasting time series data generally involves estimating or predicting time series data in the future, e.g., corresponding to events or data observations that have not happened yet. For example, a meteorological service may predict the outdoor temperature days in advanced based on various forecasting features. Such features can include historical time series data, e.g., the meteorological service could use past outdoor temperature data in order to predict the outdoor temperature in the future. Other features, such as satellite data, recorded wind patterns, ocean currents, etc., can be used to make such forecasts.

Forecasting time series data can be useful because it can aid in human planning. As an example, weather forecasts are useful to most people, and are particularly useful to farmers and travelers. Health data forecasts can be useful to doctors and patients as they may enable those individuals to predict and avoid or otherwise mitigate diseases. Demand forecasts can be useful to producers and service providers, as they can enable those entities to scale up (or scale down) the supply of goods or services in order to accommodate demand.

However, time series forecasting is often inaccurate and computationally, temporally, or monetarily expensive. Many statistical analysis and machine learning techniques are poorly suited to time series data, due to the temporal relationship between data values or observations, further limiting the adoption and use of time series forecasting techniques.

Embodiments address these and other problems, individually and collectively.

### SUMMARY

Embodiments of the present disclosure are directed to methods and systems for performing time series forecasting using ensemble machine learning models. Using such methods, future time series data can be predicted using historical time series data. In this way, a computer system (or other device or system implementing such methods, e.g., a distributed computing system comprising multiple computing nodes) can predict or forecast various forms of time series data, such as the outdoor air temperature or chance of precipitation in an upcoming week; a patient's future heartrate, cholesterol levels, or blood glucose levels in upcoming years; the future demand for a service (e.g., an item fulfillment service) over a given period of time, or any other data that can be expressed as a time series. In some embodiments, such a computer system can deliver such predictions to a requestor, e.g., an individual (or e.g., another device or computer system) who wants an accurate weather forecast, a doctor who wishes to forecast patent health data, or a service provided that wants accurate predictions corresponding to future demand for their service.

Some embodiments or aspects of embodiments are referred to by the acronym “ELITE”, which stands for “Ensemble Learning for Improved Time Series Estimation”. For example, an ensemble machine learning model according to embodiments may be referred to as an “ELITE model” or an “ELITE forecasting model”, a computer system or other device implementing such an ensemble machine learning model may be referred to as an “ELITE system”, and methods for training or using such ensemble machine learning models may be referred to as “ELITE methods”.

In general, in methods according to embodiments, multiple machine learning models (sometimes referred to as “base models” or “base learners”) can be trained to forecast time series data based on historical time series data. The forecasts produced by these machine learning models can be used as features to an ensemble machine learning model (sometimes referred to as a “super learner”) along with optional external features. The ensemble machine learning model can produce forecast time series data, which can then be, e.g., provided to a requestor or used for some other purpose. For example, the forecast time series data could correspond to forecasted electricity demand, and a power plant could adjust the supply of power based on the forecasted demand. As discussed in more detail in the Detailed Description below, forecasts produced by the ensemble machine learning model are typically more accurate than forecasts produced by any individual base learner. As described below, one implementation of methods according to embodiments resulted in approximately a 10-12% improvement in accuracy over any individual base learner as a result of using an ensemble of forecasts from multiple base learners.

Some embodiments of the present disclosure make use of a novel training method in order to train the ensemble machine learning model. This method is similar to k-folds cross validation, but involves novel techniques for preserving the temporal ordering of folds of time series data, thereby enabling training of the ensemble machine learning model. This is in contrast to typical k-folds cross validation, in which the step of randomization or otherwise shuffling folds removes useful temporal information contained in training data.

As a summary, in methods according to embodiments, a data set comprising time series data can be partitioned into segments and folds (also referred to as “segment groups”). Each segment group can comprise a time series training data set and a time series test data set. After training each base learner for each fold, each base learner can produce forecast data corresponding to the time series test data sets. By comparing the forecast data produced by the base learners to the actual time series data (contained in the time series test data sets, and sometimes referred to as “actuals”), it is possible to evaluate the accuracy of each base learner. These forecasts and actuals can be used to train the ensemble machine learning model to generate a combined forecast based on the forecasts produced by each base learner, e.g., by weighing each forecast based on the estimated accuracy of each base learning model, which can be determined by comparing forecasts and actuals.

Additionally, embodiments of the present disclosure relate to methods for parallel training of base learner models and ensemble machine learning models using computing node groups and distributed computing system. A computing node group can comprise an ensemble computing node, tasked with training and/or using an ensemble machine learning model, and a plurality of base model computing nodes, each tasked with training and/or using a plurality of machine learning models (e.g., base learners). In this way, the ensemble machine learning model and the plurality of base model computing nodes can be trained in parallel, greatly reducing the total training time. Further, a distributed computing system can comprise multiple computing node groups. Each computing node group could, for example, correspond to a different forecasting target. For example, for a weather forecasting system, one computing node group could be used to forecast rainfall, while another computing node group could be used to forecast outdoor temperature. In some embodiments, such computing node groups can be trained in parallel. This “nested parallelization” (e.g., training both individual computing nodes in a computing node group in parallel as well as training multiple computing node groups in parallel) can further reduce model training time. As discussed in greater detail in the Detailed Description below, methods according to embodiments resulted in a 78%-83% training time reduction relative to non-parallelized grid search, demonstrating the efficiency of ELITE.

In more detail, one embodiment is directed to a method performed by a computer system. This method can be used to train an ensemble machine learning model and a plurality of base learner machine learning models. In this method, the computer system can obtain a data set comprising time series data. The computer system can partition the data set into a plurality of segments. For each segment of the plurality of segments, the computer system can create a plurality of segment groups. Each segment group can comprise a time series training data set and a time series test data set. In this way, the computer system can produce a plurality of time series training data sets and a plurality of time series test data sets. The computer system can train each machine learning model of a plurality of machine learning models using the plurality of time series training data sets, thereby producing a plurality of trained machine learning models. The computer system can use the plurality of trained machine learning models to determine a plurality of time series forecast data sets that correspond to the plurality of time series test data sets. The computer system can stack the plurality of time series forecast data sets according to time for each machine learning model. In this way, the computer system can create a plurality of stacked time series forecast data sets corresponding to the plurality of machine learning models. The computer system can train an ensemble machine learning model to generate a combined forecast using the plurality of stacked time series forecast data sets from the plurality of trained machine learning models, as well as the data set comprising time series data.

After training the plurality of machine learning models and the ensemble machine learning model using the method described above (or other applicable methods), the computer system can then use the plurality of trained machine learning models and the ensemble machine learning model for some purpose. For example, the computer system can generate a time series forecast for a requestor. The computer system can receive a request from the requestor to generate a requested time series forecast data set corresponding to a request data set. The computer system can obtain the request data set. The computer system can use the plurality of trained machine learning models and the request data set to generate a plurality of requested time series forecast data sets. The computer system can generate the requested time series forecast data set using the ensemble machine learning model and the plurality of requested time series forecast data sets. The computer system can provide the requested time series forecast data set to the requestor.

Another embodiment is directed to a method performed by a computing node group comprising an ensemble computing node and a plurality of base model computing nodes. This method can be used by the computing node group to train an ensemble machine learning model and a plurality of base learner machine learning models in parallel. The computing node group can obtain a data set comprising time series data. The computing node group can partition the data set into a plurality of segments. For each segment of the plurality of segments, the computing node group can create a plurality of segment groups. Each segment group can comprise a time series training data set and a time series test data set. In this way, the computing node group can produce a plurality of time series training data sets and a plurality of time series test data sets. The computing node group can distribute the plurality of time series training data sets to the plurality of base model computing nodes. Each base mode computing node can train at least one respective machine learning model of a plurality of machine learning models using the plurality of time series training data sets, thereby producing a plurality of trained machine learning models corresponding to the plurality of base model computing nodes. Each base model computing node can use a respective trained machine learning model to determine a plurality of time series forecast data sets that correspond to a respective plurality of time series test data sets. The computing node group can stack a respective plurality of time series forecast data sets according to time for each trained machine learning mode, thereby creating a plurality of stacked time series forecast data sets corresponding to the plurality of trained machine learning models. The ensemble computing node can train an ensemble machine learning model to generate a combined forecast. The ensemble machine learning model can be trained using the plurality of stacked time series forecast data sets and the time series data.

In some cases, the computing node group can comprise a first computing node group, which can be part of a larger distributed computing system comprising one or more second computing node groups. Each computing node group can train their own respective ensemble machine learning model and plurality of base learner machine learning models to generate time series forecasts corresponding to various forecasting targets. In such cases, the first computing node group and the one or more second computing node groups can each obtain their respective time series data sets from a coordinator computer, which may coordinate the computing node groups in the distributed computing system.

After training the plurality of machine learning models and the ensemble machine learning model using the method described above (or other applicable methods), the computing node group can then use the plurality of trained machine learning models and the ensemble machine learning model for some purpose. For example, the computing node group can generate a time series forecast for a requestor. The computing node group can receive a request from the requestor to generate a requested time series forecast data set corresponding to a request data set. The computing node group can obtain the request data set. The computing node group can distribute the request data set to the plurality of base model computing nodes. Each base mode computing node can use a respective trained machine learning model to determine a respective time series forecast data set. In this way, the computing node group can generate a plurality of requested time series forecast data sets. The ensemble computing node can generate the requested time series forecast data set using the ensemble machine learning model and the plurality of requested time series forecast data sets. The computing node group can provide the requested time series forecast data set to the requestor.

As described above, in some cases, the computing node group can comprise a first computing node group, which can be part of a larger distributed computing system comprising one or more second computing node groups. In such a case, the distributed computing system could provide, e.g., a plurality of time series forecasts to a requestor. For example, the distributed computing system (or, e.g., a coordinator computer that is part of the distributed computing system and/or coordinates the distributed computing system) can provide a first requested time series forecast data set and one or more second requested time series forecast data sets to the requestor. In such a case, the first computing node group could generate the requested time series forecast data set (e.g., using the method summarized above or any other applicable method) and the one or more second computing node groups could similarly generate the one or more second requested time series forecast data sets.

Some other embodiments are directed to computer systems (e.g., computers, computing nodes, and computing node groups) and other devices configured to perform the above-noted methods and other methods. For example, one embodiment is directed to a computer system comprising a processor and a non-transitory computer readable medium coupled to the processor. The non-transitory computer readable medium can comprise code, executable by the processor for performing the above-noted methods (or other methods described herein).

### TERMS

A “server computer” may refer to a computer or cluster of computers. A server computer may be a powerful computing system, such as a large mainframe. Server computers can also include minicomputer clusters or a group of servers functioning as a unit. As one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). A client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “distributed computing system” may refer to a network of computers operating together to perform a computing task. Distributed computing can be used to parallelize computing tasks so that they can be performed more quickly by a distributed computing system than an individual computer. Computers in a distributing computing system may be referred to as “computing nodes.” A “computing node group” may refer to some collection of computing nodes, e.g., a subset of computing nodes within a distributed computing system. A “coordinator computer” may refer to a computer or computer system that manages a distributed computing system, e.g., by distributing computing tasks or subtasks among computing nodes in the distributed computing system. A coordinator computer may be included in a distributed computing system.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “message” may refer to any information that may be communicated between entities. A message may be communicated by a “sender” to a “receiver,” e.g., from a server computer sender to a client computer receiver. The sender may refer to the originator of the message and the receiver may refer to the recipient of a message. Most forms of digital data can be represented as messages and transmitted between senders and receivers over communication networks such as the Internet.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses a delivery service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may refer to any suitable electronic device that can be used by a user. An exemplary user device can process and communicate information to other electronic devices. The user device may also each include an external communication interface for communicating with other entities. Examples of user devices may include mobile devices such as mobile phones and laptop computers, wearable devices (e.g., glasses, rings, watches, etc.), hardware modules such as a touch screen device within a larger devices such as an automobile, etc.

A “transporter” may refer to an entity that transports something. For example, a transporter can be a person that transports an item using a transporter vehicle (e.g., a car). Alternatively, a transporter can refer to a transporter vehicle that may not be operated by a human. Examples of transporter vehicles include cars, boats, scooters, bicycles, drones, airplanes, etc.

A “fulfillment request” may refer to a request to provide a resource in response to the fulfillment request. For example, a fulfillment request can include an initial communication from an end user device to a central server computer to fulfill a purchase request for a resource, e.g., a purchase request for food from a restaurant. A fulfillment request can include one or more selected items from a selected service provider. A fulfillment request can also include user features of the end user providing the fulfillment request.

An “item” may refer to an individual article or unit. An item can be a thing that is provided by a service provider. An item can be a good, such as a bowls of soup, a soda can, a toy, clothing, etc. An item can be delivered from a service provider location to an end user location by a transporter.

A “time series” or “time series data set” may refer to a chronologically ordered sequence of data values or observations. Such data values or observations can correspond to one or more quantities. For example, a time series can correspond to an individual's heighted (measured in a quantity of centimeters) and weight (measured in a quantity of kilograms) over a period of time. In some cases, there can equal intervals of time between successive data values or observations, for example, each observation in a time series may be spaced one month apart in time. In such a case, the rate at which data or observations are collected or sampled can be referred to as the sampling rate. Each data value or observation may be associated with a timestamp, time value, or index, which may enable the chronological ordering of the data values in the time series. A “segment” or “subsequence” of time series data can comprise a subset of consecutive data values from a time series data set. Segments may be produced, identified, or defined using timestamps, time values, or indices.

A “forecast” may refer to a prediction or estimate of future events or trends. “forecast data” or a “forecast data set” may refer to data corresponding to such a prediction or estimation. For example, the predicted outdoor temperature in Fahrenheit or Celsius from a weather forecast may comprise forecast data. A “time series forecast” may refer to a forecast that comprises a time series (or a time series data set, a data set comprising time series data, etc.).

A “feature” can refer to an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency metrics for textual terms. Feature vectors can be equivalent to the vectors of explanatory variables used in statistical procedures such as linear regression.

“User features” can refer to attributes or aspects of a user. User features can include features that relate to a user. For example, in the context of a delivery service, user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” may refer to attributes or aspects of a service provider. Service provider features can include service provider details, cuisine, ratings, food category, service provider location(s), item production time, promoted items, item cost, and/or other data representative of the service provider and/or items provided by the service provider.

The term “artificial intelligence model” or “machine learning model” may refer to a model that may be used to predict outcomes to achieve a pre-defined goal. A machine learning model may be developed using a learning process, in which training data is classified based on known or inferred patterns.

“Machine learning” may refer to artificial intelligence processes in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or a recommendation (e.g., a movie that a user may like or a restaurant that a consumer might enjoy).

A “machine learning model” may refer to an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and can apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

An “ensemble machine learning model” may refer to a machine learning model that combines or otherwise “ensembles” the outputs of multiple “sub-model” machine learning models (also referred to as “base models”). For example, an ensemble machine learning model for handwriting identification can combine the outputs of a support vector machine and a neural network to produce a single classification corresponding to a handwriting sample.

### BRIEF DESCRIPTION OF THE DRAWINGS

FIG. 1 shows a diagram of an exemplary computer system that can be used to perform ensemble time series forecasting methods according to some embodiments.

FIG. 2 shows a diagram of an exemplary machine learning model comprising a base layer and an ensemble layer that can be used to perform ensemble time series forecasting according to some embodiments.

FIG. 3 shows a diagram summarizing an exemplary process for training a plurality of base machine learning models and an ensemble machine learning model using segmentation and stacking according to some embodiments.

FIG. 4 shows a flowchart summarizing an exemplary method for training a plurality of base learner machine learning models and an ensemble machine learning model according to some embodiments.

FIG. 5 shows a flowchart summarizing an exemplary method for using a plurality of trained machine learning models and a trained ensemble model to provide a forecast to a requestor according to some embodiments.

FIG. 6 shows a diagram depicting an exemplary parallelization method used to train ensemble models and base learning models using a distributed computing system according to some embodiments.

FIG. 7 shows a block diagram of an exemplary distributed computing system that can be used to train a plurality of base machine learning models and a plurality of ensemble machine learning models to perform ensemble time series forecasting according to some embodiments.

FIG. 8 shows a flowchart summarizing an exemplary method, performed

by a computing node group, for training a plurality of base machine learning models and an ensemble machine learning model according to some embodiments.

FIG. 9 shows a flowchart summarizing an exemplary method, performed by a computing node group, for using a plurality of trained machine learning models and a trained ensemble machine learning model to provide a forecast to a requestor according to some embodiments.

FIG. 10 shows a first table detailing the results of an experiment relating to an implementation of an embodiment of the present disclosure.

FIG. 11 shows a second table detailing additional results of an experiment relating to an implementation of an embodiment of the present disclosure.

FIG. 12 shows a graph relating the accuracy of machine learning models

to their level of specialization.

FIG. 13 shows an exemplary computer system according to some embodiments of the present disclosure.

### DETAILED DESCRIPTION

As summarized above, embodiments of the present disclosure relate to time series forecasting. It is assumed that a potential practitioner of methods according to embodiments is generally knowledgeable regarding time series data and forms of time series analysis, including forecasting. As such, time series analysis and forecasting are not described in great detail herein. However, some aspects of time series analysis and forecasting are summarized below, in order to orient the reader and facilitate a better understanding of embodiments of the present disclosure.

A time series (or “time series data”, or “time series data set”, or “a data set comprising time series data”) typically refers to a sequence of data values or observations organized chronologically. Often, each data value or observation is associated with a corresponding time stamp or index value, which can be used to determine the relative chronological position of each data value or observation, or can otherwise be used during time series analysis. For example, a pressure sensor in a distillery may monitor the pressure in a tank of liquid, and may record pressure values and associated timestamps (e.g., corresponding to the times at which those pressure values were recorded) in a time series data set. Similarly, the pressure sensor could monitor the pressure in the tank at a set sampling rate, e.g., once per second (1 Hz) and could record the pressure values and associated indices in a time series data set. An index such as “100” could indicate that a particular pressure data value comprises the 100^{th} data value recorded by the pressure sensor. An individual or computer system, knowledgeable about e.g., a 1 Hz sampling rate, could determine that the 100^{th} pressure data value was recorded on the 100^{th} second of pressure recording.

Indices or timestamps can be used to subdivide sequences of time series data into subsequences, which can be analyzed or otherwise processed individually. For example, a subsequence comprising the first 100 pressure sensor data values could correspond to the first 100 seconds of pressure recordings, while a subsequence comprising the second 100 pressure sensor data values could correspond to the second 100 seconds of pressure recordings. By averaging the pressure recordings in each subsequence, a data scientist could evaluate, e.g., whether there is a trend in pressure sensor data values. Other forms of analysis can also be performed by dividing sequences of time series data into subsequences.

Time series forecasting generally refers to the process of predicting future time series data. Time series forecasting is often performed using past or historical time series data. For example, the pressure in a particular tank over a five minute interval in the future could be predicted based on pressure data values collected over the past hour. There are a variety of techniques and models that can be used to perform time series forecasting. For example, a “moving average model” can predict future time series data values based on a moving average of previous time series data values, or a moving average of the change in previous time series data values.

Further, and as summarized above, embodiments of the present disclose relate to the use of machine learning and ensemble machine learning models for time series forecasting, as well as novel methods of training and using such machine learning models. It is assumed that a potential practitioner of methods according to embodiments is generally knowledgeable regarding machine learning. As such the principles of machine learning and specific machine learning models (e.g., neural networks, linear regression models, logistic regression models, etc.), are not described in great detail herein. However, some basic concepts in machine learning are presented below, in order to orient the reader and facilitate a better understanding of embodiments of the present disclosure.

Many machine learning models use a data set as an input in order to produce an output, which may also comprise a data set. Inputs to a machine learning model are sometimes referred to as “features,” which can be organized in “feature vectors.” The nature of the inputs and outputs generally depend on the task performed or problem solved by the machine learning model. For example, an English to Spanish machine learning translation system may receive input data comprising English text and generate output data comprising a Spanish text translation of the input English text.

Machine learning models are typically governed by parameters, which often relate the mapping between inputs and outputs. In a neural network, for example, parameters can comprise “weights”, which can correspond to the relative weight given to the output of a given neuron on the output of another neuron. Typically, changing the parameters of the machine learning model will change how the machine learning model performs its particular task. For example, for a given set of parameters and an input “A”, a machine learning model may produce an output “B” (e.g., a classification of the input “A”), however, for a different set of parameters and the same input “A”, the machine learning model may produce a different output “C” (e.g., a different classification of the input “A”). Generally, some sets of parameters will typically result in better performance at a given task or problem than other sets of parameters for a given machine learning model. For example, for a machine learning translation system, some sets of parameters may result in more accurate translations than other sets of parameters.

While it is often computationally infeasible to find the “best” set of parameters for given task, the process of “training” a machine learning model typically involves determining a satisfactory set of parameters for a machine learning model for its given task. For example, for a machine learning translation system, training may involve determining a set of parameters that enables a machine learning translation system to translate e.g., a page of text with few grammatical or other translation errors. The performance of a machine learning model can be quantified using statistics such as “loss terms” or “loss values” (also referred to as “error terms” or “error values”), scores, or other numerical quantifiers. The process of training can involve determining parameters that minimize (or maximize) these statistics.

There are many ways in which training based on error terms can be performed, and an exhaustive list will not be provided. Some methods involve the use of optimization techniques such as “gradient descent” or “stochastic gradient descent.” The gradient of an error term with respect to model parameters can be used to determine the change in model parameters that results in the greatest immediate reduction of the error term. By performing numerous “training rounds” and updating the model parameters in view of gradients in each training round, corresponding error terms can be reduced. Since the error terms generally relates to the model's performance (in that a smaller error term typically corresponds to a better performing machine learning model), iteratively updating model parameters by reducing error terms results in better performing machine learning models.

There are a variety of forms of machine learning, including unsupervised, supervised, and semi-supervised machine learning. They will not be described in detail, however supervised learning is summarized briefly below. In supervised learning, a “training data set” can be used to train a machine learning model. Often, this training data set can comprise input data and corresponding desired or expected output data. For example, in the context of a machine learning English to Spanish translation system, the training data set could comprise English language sentences and their corresponding Spanish language translations. As another example, in the context of a classifier, “labels” corresponding to input data can be paired with that input data and used as a training data set.

Such training data sets enable the derivation of statistics (such as error terms) that can be used to train the machine learning model. For example, input data from a training data set can be input into an untrained or partially trained machine learning model, producing a model output. Because the ideal or expected model output is already contained in the training data set, the ideal or expected model output can be compared against the actual model output in order to derive, e.g., a loss or error term. For example, if an untrained or partially trained translation system produces a translation that is very similar to the ideal or expected translation, then the resulting error term may be small. By contrast, if the untrained or partially trained translation system produces a translation that is very dissimilar to the ideal or expected translation, then the resulting error term may be large.

Regardless, model parameters can be updated in view of any error terms (e.g., based on gradients as described above) during training, in order to reduce the error terms across the entire training data set and thereby train the machine learning model. Often, training is performed until some terminating condition has been met. Such a terminating condition can comprise a set number of training rounds, epochs, or passes through the entire training data set. Another example is convergence, in which the training ends when model parameters or error terms become unchanging (or only change to a small degree) in each successive training round. Provided that the training data set is relatively representative of data the model might encounter in “the real world”, using supervised training can result in machine learning models that are effective or accurately perform their respective tasks.

However, it should be understood that the term “machine learning model” can generally refer to any model with parameters that can be tuned, automatically or otherwise, to better fit the model to a particular dataset or task, and that techniques such as the use of multiple training rounds or stochastic gradient descent are not necessary for something to be considered machine learning. Even well-established statistical techniques such as linear, polynomial, exponential, or logistic regression can be considered machine learning.

Having briefly summarized some time series forecasting and machine learning concepts, some practical aspects and difficulties associated with time series forecasting are described below.

In many real world forecasting applications, it can be difficult to balance forecasting speed and accuracy. High accuracy can sometimes be achieved by operating numerous models and configurations combinations, and high speed can be achieved by executing individual fast, computationally inexpensive models. Unfortunately, it can be challenging to design and implement a forecast model that is both accurate, fast, and computationally inexpensive to operate. However, time series forecasting methods according to embodiments can maintain accuracy while reducing model execution times, making it feasible to generate forecasts on targets with high dimensionality.

Using methods and models according to embodiments, it is possible to achieve computation costs savings via a computationally efficient training framework. Further, embodiments can optimize infrastructure settings to accommodate the training process on computing clusters, including efficient computing clusters such as Ray clusters. Additionally, embodiments can simplify the process of model maintenance by enabling data scientists and engineers to easily “swap in” or “swap out” ensemble models in an automated fashion, using, e.g., standardized model wrappers.

In general, forecasting models have historically progressed from traditional time series frameworks to increasingly complex deep learning architectures in order to capture the volatile dynamics of real-world scenarios. However, it is generally unrealistic to subjectively select a single model to produce accurate forecasts for multiple forecasting targets, as there is generally too much variation in forecasting targets. For example, a single weather model used to forecast rainfall, outdoor temperature, and wind speed may not be able to produce accurate forecasts on these distinct forecasting targets.

As such, some time series forecasting practices involve using a “forecasting toolbox” to apply a model selection framework. Such a model selection framework can evaluate a variety of models and model configurations, and evaluate the performance of said models and model configurations on each forecasting target. The models and model configurations that achieve the “best” (e.g., the most accurate) performance can be used to produce the final forecasts for those forecasting targets. The configuration space can include both model parameters and options for processing input data (e.g., data cleaning, data transformation, outlier handling (such as outlier detection and removal), etc.), and can also include causal or external factors. In the context of an item fulfillment service, causal factors can include holidays, weather, promotions, etc. A “forecast factory” can refer to a set of software, applications, methods, etc., that can be used to perform the functions described above, e.g., evaluating the performance of models and model configurations on different forecasting targets.

However, there are limitations associated with these forecasting strategies, particularly related to computational burden, as training increasingly complex models increases training complexity. Further, configuration combinations can grow exponentially as additional configuration options are added to forecasting models, or additional forecasting models are added to a model selection framework. For example, for a model with ten configurations, each configuration with two configuration options, there are 2¹⁰=1024 possible configuration combinations. If an additional option is added to a single configuration, the configuration combinations increase by 29 to a total of 1536 combinations.

Techniques such as grid searching can be used to determine more performant configuration combinations for forecasting models. However, due to the exponential growth in configuration combinations with additional configurations (as described above), it may be necessary to perform an exhaustive grid search over a large number of configuration combinations (e.g., thousands, hundreds of thousands, millions, etc.) on average for each forecasting target, which can result in hours (or tens of hours, hundreds of hours, etc.) of execution time per modelling run. Moreover, rolling window cross validation processes can be applied to evaluate the forecasting performance for each model, which can in turn increase the execution time. Although grid search methods can maintain high accuracy for a variety of forecasting targets, grid search also can significantly increase both run time and computational costs with an increasing number of use cases.

Further, for some applications, forecasts may need to be generated for a large number of highly granular forecasting targets, which can make training and executing forecasting models more computationally expensive or even computationally prohibitive. One application of time series forecasting is the generation of covariates in switchback experiments, which can be used to reduce variance and produce more useful data for experimenters. However, when there are e.g., tens of thousands of forecasting targets associated with those experiments, computational limitations can prevent such experiments from being performed due to unacceptably long model run times or high cluster costs.

Conceptually, a single forecasting model can be used to reduce computational cost. However, individual models often have limitations that make them ineffective or inaccurate to use on their own. For example, single forecasting models often suffer from unrealistic or oversimplistic assumptions that are not easily satisfied. For example, a single seasonality assumption can be violated by the complex multiple seasonality patterns that exist in reality (such as seven day weekly seasonality patterns and 52 week annual seasonality patterns).

Another limitation is biased model strength. Forecasting models with

different configurations may only be accurate at making forecasts at particular stages in a forecasting horizon (i.e., the length of time into the future for which forecasts are to be prepared). For example, a model with extreme weather processors can overperform when there are sudden weather changes, but can underperform if forecasting targets follow normal trend and seasonality patterns. Such limitations may be important when making long-term forecasts because deviant trends and patterns can accumulate over time along the forecasting horizon. Further, single models can suffer from general model instability, i.e., forecasts from a single model can, for example, produce sharply increasing or decreasing patterns within short time periods or can produce extreme values, which may have questionable forecasting utility.

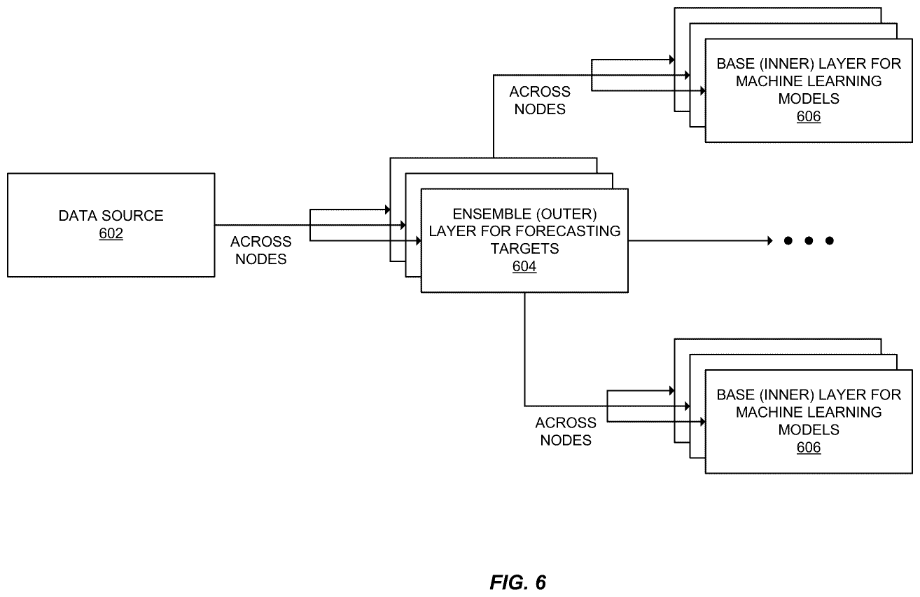

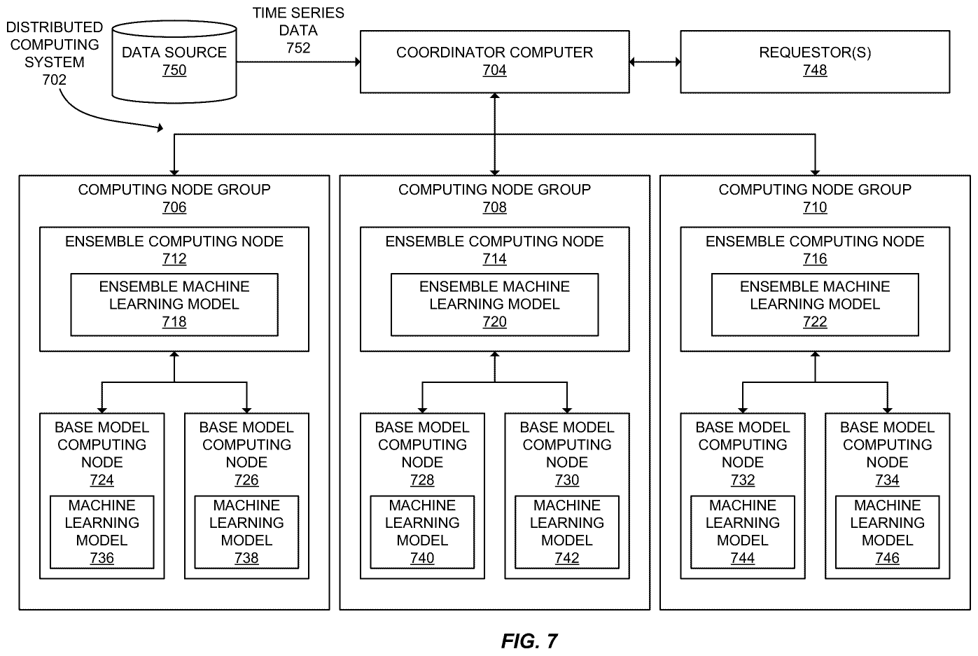

Embodiments of the present disclosure solve some of these real world forecasting challenges described above using a temporal stacking ensemble machine learning approach. In general, rather than relying on a single model, embodiments of the present disclosure can use an ensemble machine learning model to ensemble forecasts from a plurality of machine learning models (sometimes referred to as “base learners”, “base learner machine learning models”, “candidate models” or other similar terms). Embodiments of the present disclosure can apply two layers of parallelization (also referred to as “nested parallelization”, see, e.g., the description of FIGS. 6 and 7 further below). Further, some embodiment can use an effective model wrapper that enables arbitrary choice of base machine learning models and ensemble machine learning models. As such, embodiments of the present disclosure offer several benefits, including higher accuracy, better efficiency and cost, better extensibility and reduced operating risks. Further, time series forecasts according to embodiments can be used in a wide variety of contexts or applications, including, e.g., item fulfillment services.

As a general review, an “ensemble machine learning model” typically refers to a machine learning system comprising multiple sub-models, each of which produces some output. These outputs can be “ensembled” (e.g., combined) to produce a single output, which can be considered the output of the ensemble model as a whole. One such ensemble method is the use of weighted averages. For example, for an ensemble machine learning model comprising five sub-models, each of which produces a numerical output (e.g., a probability corresponding to the likelihood of an event happening), each numerical output can be multiplied by a corresponding weight, and the resulting products can be summed to produce the output of the ensemble machine learning model.

Ensemble models can perform better than the individual sub-models that have been ensembled. As such, using ensemble models can result in improved accuracy. Further, stacking ensemble models (e.g., according to embodiments of the present disclosure) can achieve smaller bias than single base models and can outperform Bayesian model averaging. Different base learners can have different strengths in capturing or otherwise identifying different temporal patterns in periods along the forecasting horizon, and an ensemble model can combine forecasts from different base learners in a way that each base learner's individual strengths are captured, resulting in improved forecasting accuracy.

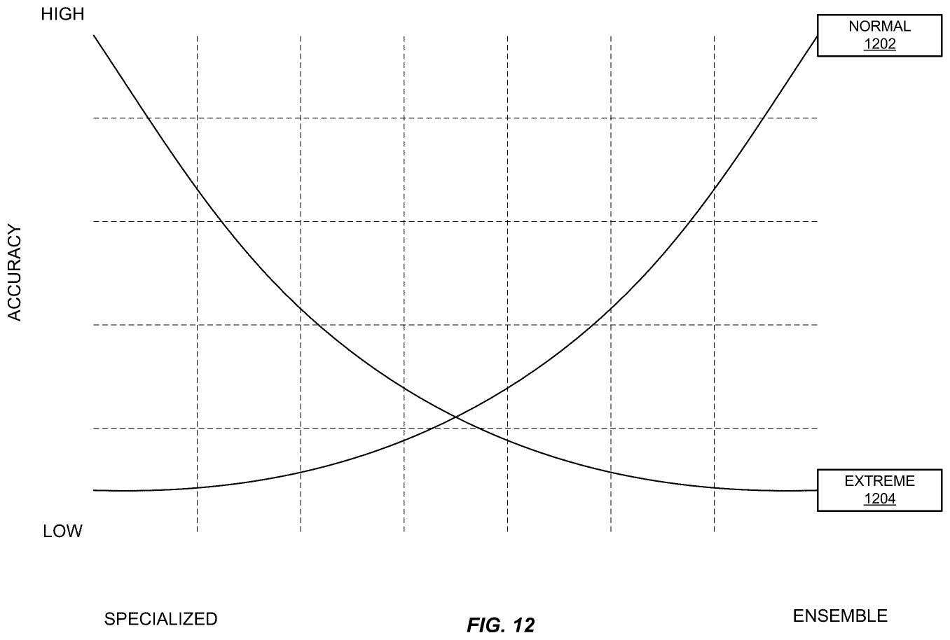

However, in some cases ensemble models can be less effective than non-ensembled machine learning models. This can be true when individual machine learning models are highly specialized. FIG. 12 shows a graph generally depicting this phenomena. As depicted in FIG. 12, specialized models typically have higher accuracy than ensemble models in extreme cases (e.g., extreme case 1204), while ensemble models typically have higher accuracy than specialized models in normal cases (e.g., normal case 1202). This can be because combining (or otherwise producing an ensemble of) the output of a highly representative (i.e., specialized) model with the outputs of less representative models may reduce the highly representative model's ability to detect extreme patterns.

For example, a specialized rain forecasting model could be used to forecast rainfall during extreme or infrequent weather situations (e.g., during hurricanes), while a less specialized rain forecasting model could be used to forecast rainfall during “normal” or typical weather. The specialized rain forecasting model is expected to perform accurately during extreme weather, but somewhat inaccurately during normal weather, while the less specialized rain forecasting model is expected to perform less accurately during extreme weather and more accurately during normal weather. An ensemble model including the specialized rain forecasting model and normal rain forecasting model will typically perform worse than the specialized rain forecasting model alone during extreme weather, but will perform better than the specialized rain forecasting model alone during normal weather. This is depicted in the graph of FIG. 12, in which the accuracy increases in extreme cases 1204 as models become more specialized (shown in FIG. 12 in the negative x direction), and decreases as models become more ensembled (as shown in the positive x direction). On the other hand, in normal cases 1202, accuracy can increase as models become more ensembled and decrease as models become more specialized.

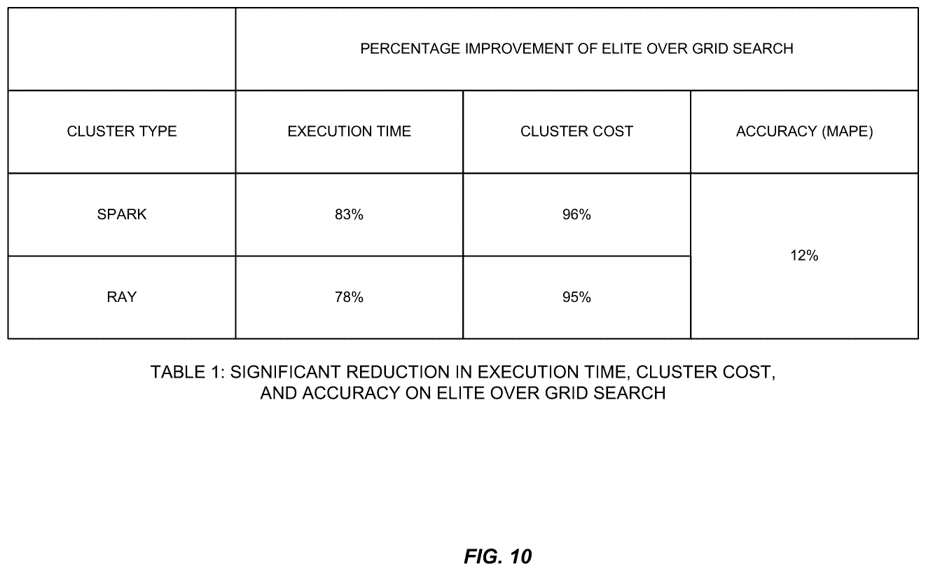

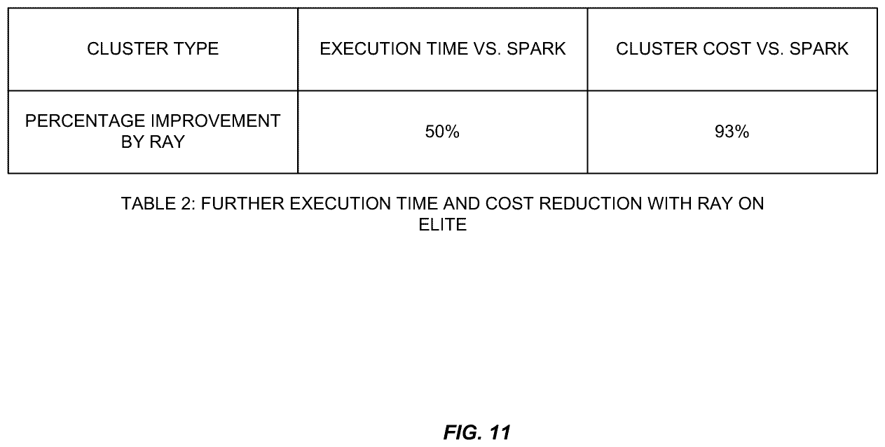

Even still, ensemble time series forecasting models according to embodiments outperform single base models in experiments. For example, an ensemble model according to embodiments (e.g., an ELITE forecasting model) was used in an experiment related to weekly order volume across several thousand item fulfillment service submarkets (e.g., defined geographic regions, such as neighborhoods or other districts within cities). As described below with reference to FIGS. 10 and 11, results showed that methods and models according to embodiments were approximately 10% more accurate than the best single model tested in the experiment, demonstrating the accuracy and usefulness of embodiments of the present disclosure.

As such, embodiments of the present disclosure address the performance limitations of time series forecasting using a single model, as described above. Producing forecasts from multiple models can weaken imposed model structure assumptions from single models, and using an ensemble model can extract the strengths of each ensembled model, improving forecasting performance. The combined forecasts from multiple base models can take advantage of strong model performers at different forecasting stages. Further, ensemble models according to embodiments of the present disclosure can produce more stabilized forecast values by using a diverse set of base models.

Additionally, methods according to embodiments can reduce or eliminate the need for heavy rolling window cross validation, which reduces both running time and computational costs. For example, using ensemble models according to embodiments in an experiment on complex time series forecasting reduced model training time from hours to minutes, and further lowered computational costs by over 80%. As such, ensemble time series frameworks according to embodiments can unblock complex objectives, including high granularity forecasting tasks, such as experimentation variation reduction for highly granular switchback levels (e.g., the time and geographic units on which switchback experiments are being performed). By contrast, grid search frameworks can fail to complete a grid search within an acceptable amount of time for such applications.

Additionally, embodiments of the present disclosure can also improve forecasting flexibility by supporting a variety of user derived models using a standardized module wrapper in the ensemble modeling framework, and forecasting models according to embodiments can make use of external features, which can support machine-learning or deep-learning models and/or forecasts that require such features. Further, frameworks according to embodiments can provide valuable information for analyzing or investigating base models, e.g., by tracking how base forecasts contribute to ensemble forecasts. Such base model diagnostic analysis can aid model developers in forming a better understanding of each base model's capability in capturing a forecasting target's changing patterns.

As yet another benefit, ensemble time series forecasting methods according to embodiments can eliminate the step of selecting the best model performers from the base models (e.g., as described above in the context of a “forecasting toolbox” or “forecasting factory”), a step that can involve training each model repeatedly on a sequence of run dates along the historical timeline. As such, embodiments of the present disclosure can simplify what otherwise can be a complicated model validation process, reducing the effort required for model maintenance. Further, because the ELITE forecasting model may only use the estimated effect from each base learner, the amount of time needed to train base models can be reduced. This reduced computational burden also improves system stability in distributed computing tasks, reducing the risk of overstepping computational limits.

Having generally summarized time series forecasting and machine learning, described practical aspects and problems associated with real world time series forecasting, and described the advantages of ensemble forecasting methods and models according to embodiments, it may now be helpful to describe systems and methods according to embodiments in more detail.

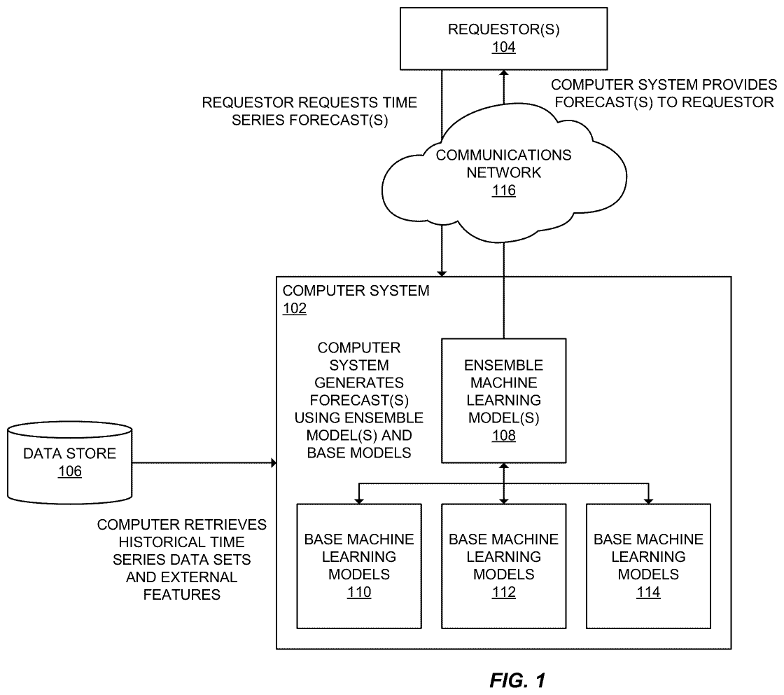

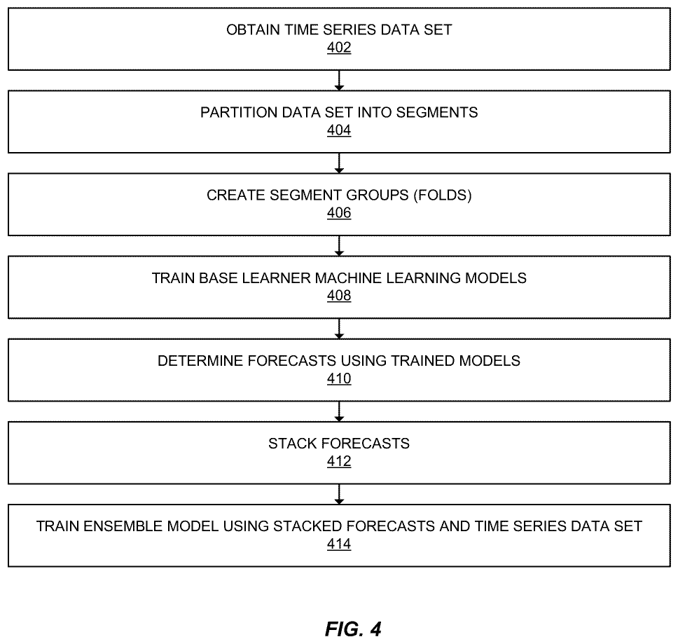

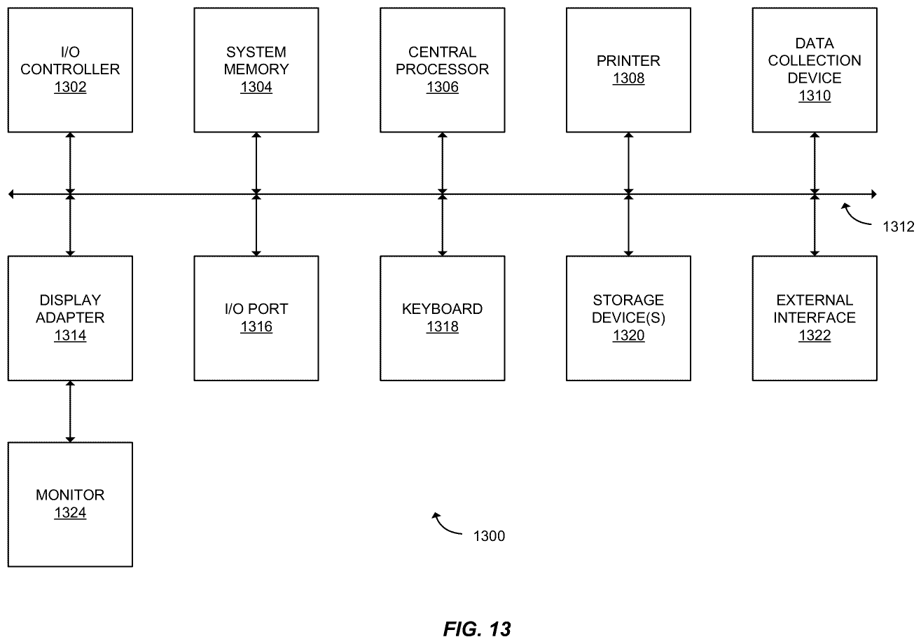

A time series forecasting system according to some embodiments is summarized with reference to FIG. 1. Such a system can include a computer system 102, which can instantiate, train, and utilize ensemble machine learning model(s) 108 and a plurality of base machine learning models, e.g., base machine learning models 110-114. It should be understood that although only one ensemble machine learning model 108 and three base machine learning models 110-114 are depicted in FIG. 1, a computer system 102 according to embodiments can comprise any number of ensemble machine learning model(s) 108 and base machine learning models 110-114. The computer system 102 can be configured to perform forecasting methods according to embodiments described herein, e.g., forecasting methods described below with reference to FIGS. 4, 5, 8, and 9. As described in more detail with reference to FIG. 13, a computer system such as computer system 102 can comprise a processor and a non-transitory computer readable medium (e.g., a hard drive) coupled to the processor. The non-transitory computer readable medium can comprise code or instructions, executable by the processor, for performing methods according to embodiments described herein.

For simplicity of illustration, a certain number of components are shown in FIG. 1. It should be understood, however, that embodiments of the present disclosure may include more than one of each component. In addition, some systems according to embodiments of the present disclose may include a lesser number of components or a greater number of components than those shown in FIG. 1.

In some embodiments, the computer system 102 can communicate or otherwise interface with one or more requestor(s) 104. The requestor(s) 104 can request one or more time series forecasts from the computer system 102. For example, a requestor 104 could comprise a user that is requesting weather forecasts for an upcoming week. As another example, a requestor 104 could comprise an employee of an item fulfillment service that is requesting forecasts corresponding to future demand of that service. These time series forecasts can correspond to one or more forecasting targets. For example, weather forecasts could include forecasts for targets such as outdoor temperature, wind speed, precipitation, etc.

A requestor 104 can comprise a requestor computer system. As such, a requestor 104 may comprise a client computer and the computer system 102 may comprise a server computer. Requestor(s) 104 may communicate with the computer system 102 over a communications network 116. A communications network such as communications network 116 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers and devices may be transmitted using a secure communications protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like. Any suitable communications protocol can be used to communicate over the communications network 116, e.g., for the purpose of creating one or more communication channels. A communications channel may, in some instances, comprise a secure communication channel, which may be established in any known manner, such as through the use of mutual authentication, a session key, and establishment of a Secure Socket Layer (SSL) session.

In some embodiments, the computer system 102 and the requestor(s) 104 may comprise parts of the same computer network, system, or organization. For example, an item fulfillment service may possess a server (e.g., computer system 102) for the purpose of generating demand forecasts for that item fulfillment service, and a requestor 104 may comprise, e.g., an employee of the item fulfillment service or a computer terminal (e.g., an employee computer) associated with that item fulfillment service. As another example, a hydroelectric power plant can include a computer system 102 for forecasting power demand, which can be connected to a requestor 104 that comprises a control system including a hydro-electric governor, i.e., a system that governs the speed of a hydroelectric turbine. Power demand forecasts from computer system 102 can be used by the control system requestor 104 to adjust turbine output to accommodate forecasted load changes.

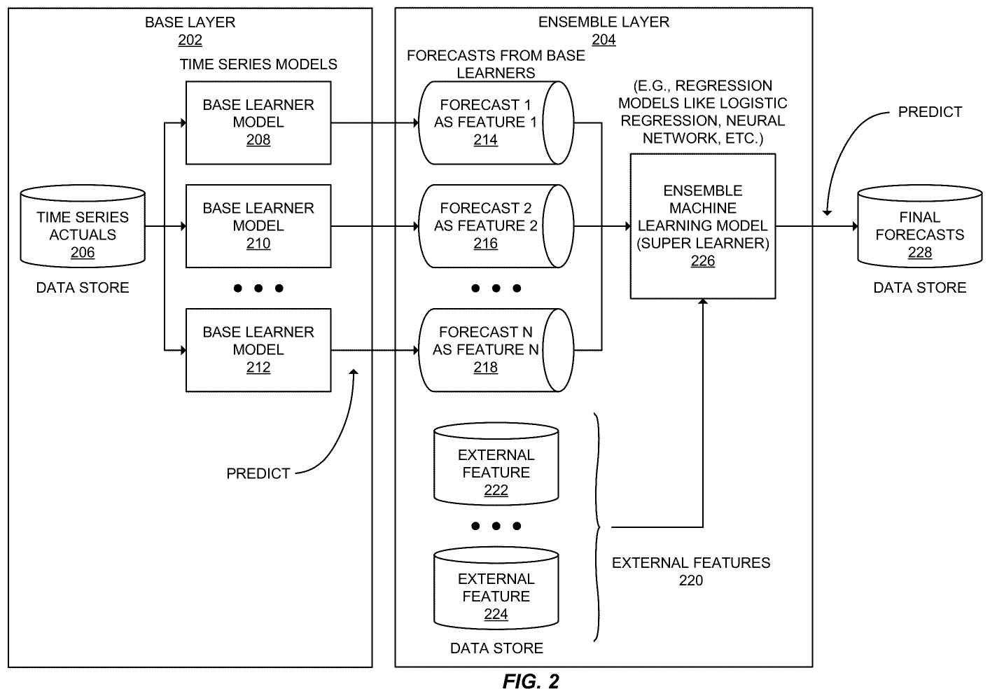

As described above, the computer system 102 can train ensemble machine learning model(s) 108 and base machine learning models 110-114 to perform time series forecasting. The computer system 102 can retrieve historical time series data, as well as any applicable external features to perform this training. Such data may be stored in a data store 106 which may comprise a database or other suitable data storage system. Such training is described in more detail with reference to FIGS. 2-4 and 6-8 further below. Some embodiments can make use of a novel training method to train the ensemble machine learning model(s) 108, which is also described in more detail further below.

In some embodiments, after training the ensemble machine learning model(s) 108 and base machine learning models 110-114, the computer system 102 can service forecasting requests from requestor(s) 104. In general, the computer system 102 can receive requests for time series forecasts from the requestor 104 (e.g., via a communication network 116 such as the Internet), then retrieve historical time series data sets and any optional external features from the data store 106. The computer system 102 can then generate requested forecasts using the ensemble machine learning model(s) 108 and base machine learning models 110-114. Afterwards, the computer system 102 can provide the requested time series forecasts to the requestor(s) 104 (e.g., via a communication network 116 such as the Internet).

Various types of base learner machine learning models 110-114 can be used for this purpose, and an exhaustive list will not be provided. However, as examples, the base machine learning models 110-114 can include models from the autoregressive and moving average “family” of models, e.g., autoregressive (AR) models, moving average (MA) models, autoregressive moving average (ARMA) models, autoregressive integrated moving average (ARIMA) models, seasonal autoregressive integrated moving average (SARIMA) models, autoregressive integrated moving average models with exogenous regressors (ARIMAX), seasonal autoregressive integrated moving average models with exogenous regressors (SARIMAX), etc. However, any other appropriate time series forecasting models (e.g., ETS models, models associated with Prophet, lightgbm, and statsmodel packages, etc.) can also be used. Some of the base learner models may comprise the same type of model, but may have different model parameters, hyperparameters, or configurations.

Similarly, various types of ensemble machine learning model(s) 108 can be used to ensemble forecasts produced by base machine learning models 110-114, and an exhaustive list will not be provided. Some examples, however, include neural networks, linear regression models, logistic regression models, transformer models, etc. In some embodiments, each ensemble model of ensemble machine learning model(s) 108 can comprise a combination model. Such a combination model can implement a weighted combination of time series forecasts produced by the base machine learning models 110-114. For such a combination model, the parameters of the model can comprise the weights corresponding to the weighted combination, and the process of training such a model can involve determining these weights.

In some embodiments, the computer system 102 can comprise a distributed computing system comprising multiple computers or computer nodes. As such, ensemble machine learning model(s) 108 and base machine learning models 110-114 can be instantiated, trained, and used (e.g., to produce time series forecasts) by multiple computing nodes. For example, each computing node could train a single machine learning model (base machine learning model or ensemble machine learning model) or could train multiple machine learning models (e.g., multiple base machine learning models, multiple ensemble machine learning models, some combination of base machine learning models and ensemble machine learning models, etc.). In some embodiments a “computing node group” may refer to a group of computing nodes that collectively train an ensemble machine learning model and some collection of base machine learning models corresponding to that ensemble machine learning model. For example, computing nodes training ensemble machine learning model 108 and base machine learning models 110-114 could comprise a computing node group. A computer system 102 or distributed computing system according to embodiments can comprise any number of computing node groups, e.g., a “first computing node group” and “one or more second computing node groups.” Distributed computing systems comprising multiple computing node groups are described in further detail below with reference to FIGS. 6 and 7.

As described in more detail below, the ensemble machine learning model(s) 108 in computer system 102 can correspond to different time series forecasting targets. For example, in the context of weather forecasting, an ensemble machine learning model could be used to produce precipitation forecasts, while another ensemble machine learning model could be used to produce air temperature forecasts. As such, each computing node group could also correspond to a different forecasting target. A computing node group could, for example, use an ensemble forecasting model to ensemble precipitation forecasts produced by a plurality of base machine learning models within that computing node group.

An exemplary ensemble time series forecasting model according to some embodiments is summarized below with reference to FIG. 2. As depicted in FIG. 2, the ensemble time series forecasting model can comprise a base layer 202 and an ensemble layer 204. Within the base layer 202, time series “actuals” 206 (e.g., historical time series data) can be input into a plurality of time series models i.e., base learner models 208-212, thereby producing a plurality of time series forecasts 214-218. The time series forecasts 214-218 from the base learner models 208-212 can be used as features for an ensemble machine learning model 226 (which can also be referred to as a “super learner” or “super learner model”). One or more external features 220 (e.g., external features 222 and 224) can also be input into the ensemble machine learning model 226. Such external features 220 can also be retrieved from a data store if applicable. Using the time series forecasts 214-218 from base learner models 208-212, in addition to optional external features 220, the ensemble machine learning model 226 can generate, predict, or otherwise produce ensembled or “final” time series forecasts 228, which can be stored in a data store if applicable. Such time series forecasts 228 can be provided to requestors if applicable, e.g., as described above with reference to FIG. 1.

One advantage of the ensemble time series forecasting model depicted in FIG. 2 is its ability to adopt different base learners. A wide variety of candidate base learner models and configurations can be used. In addition to integrating forecasting models from existing packages (such as the statsmodels package, the Prophet package, the lightgbm package, etc.) and ETS and SARIMAX models, embodiments of the present disclosure can introduce a variety of different configurations. These configurations can correspond to both underlying model structures (which can comprise, e.g., “internal configurations,” such as additive or multiplicative trends, seasonality, and error assumptions), as well as time series processing options (which can comprise examples of “external configurations,” e.g., methods or techniques to address missing values and outliers, how to adjust impacts from causal factors such as holidays, weather, promotions, etc.). These flexible base model options can result in a stronger set of forecasts 214-218 for the ensemble machine learning model 226 to use as features, thereby improving the forecasting accuracy of the system as a whole.

Some embodiments can make use of a standardized model wrapper layer to make it easier to incorporate new time series models into base layer 202, thereby improving forecasting accuracy by promoting diversity among the base models. Ensemble model accuracy can be further improved by penalizing model complexity or by using other techniques. The selection of base learner models 208-212 can be based on a variety of factors, including the number of base models or other independent variables and data sample size. A large number of base learners and sufficient data can favor more complex model structures. For some applications, it can be beneficial to choose models that are not sensitive to correlated samples, e.g., for temporal data. Methods and models according to embodiments allow for flexibility in selecting models with different levels of complexity, ranging from, e.g., linear regression models to neural networks.

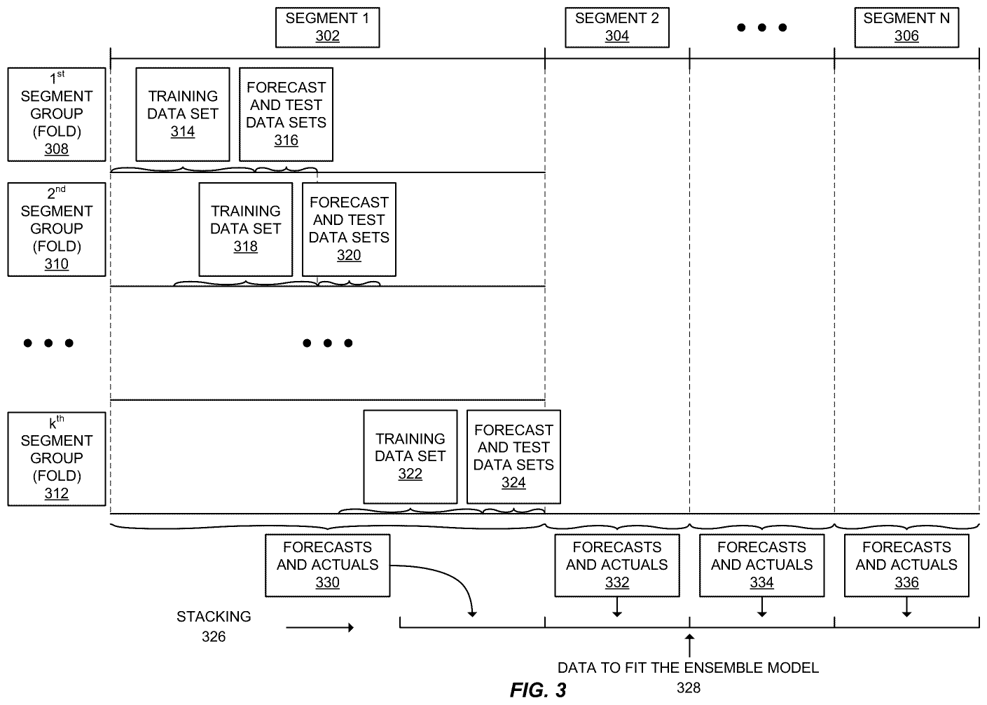

Further, the ensemble time series forecasting model of FIG. 2 can be integrated into existing “forecast factory” systems, facilitating their implementation for a variety of forecasting tasks. Some training methods according to embodiments (described in more detail below with reference to FIGS. 3, 4, and 6-8) can be decomposed into various training tasks, such as training base learner models 208-212, “stacking” base learner forecasts (described in more detail below), training the ensemble machine learning model 226, etc., and can be used to create an ensemble model class that incorporates each of their implementations. As described in more detail below with reference to FIGS. 6 and 7, it is possible to apply a nested parallelization framework to perform these training tasks in parallel. Additionally, a “runner class” can be created for running the ensemble forecasting workflow. This runner can be inherited from or adapted to existing forecasting tasks. As such, the ensemble time series forecasting model design presented in FIG. 2 provides significant advantages in terms of efficiency and generalizability, especially when used for forecasting high-granularity forecasting targets.

The ensemble machine learning model 226 can comprise any type of machine learning model that can be used to ensemble or otherwise combine the forecasts 214-218 produced by the base learner models 208-212. Non-limiting examples of such machine learning models include logistic regression models and neural networks. The ensemble machine learning model 226 can be trained using a novel training method. While similar to k-folds cross validation techniques, this novel training method preserves the temporal order of subsequences of time series data, enabling it to be used to train time series forecasting models. By contrast, conventional k-folds cross validation involves randomizing folds of data, removing the temporal relationships between those folds, and making it less useful for time series forecasting. This novel training method is summarized below with reference to FIG. 3.

FIG. 3 shows a diagram used to summarize an exemplary method for training an ensemble machine learning model (e.g., ensemble machine learning model 226 from FIG. 2) according to some embodiments. An ensemble forecasting model can be trained, in part, by estimating or otherwise determining the effect of each base forecasting model. As an example, an ensemble forecasting model could comprise a weighted combination of base forecasting models. Such a weighted combination may put more weight on base forecasting models that are more accurate and less weight on base forecasting models that are less accurate. As such, estimating or otherwise determining the accuracy of each base forecasting model can be used to train the ensemble forecasting model by enabling the determination of the weights in the weighted combination. In more detail, during training, the ensemble machine learning model weights can be solved such that the variance of an output time series forecast can be explained as much as possible by the weighted time series features (which can be generated by the base forecasting models), thereby achieving maximum goodness of fit. A more complex ensemble model could have dynamic weights, which may be useful if some of the base machine learning models are highly specialized. For example, for a weather forecasting system, a particular weather forecasting model could be specialized for extreme weather conditions. An ensemble model could weigh the forecast from that base machine learning model more heavily when weather conditions are extreme, and weigh the forecast from that base machine learning model more lightly when weather conditions are normal. Regardless, in either case an ensemble machine learning model can be trained in part by estimating or otherwise determining the effects of individual forecasting models.

Novel stacking temporal k-fold cross validation frameworks are one method that can be used for estimating the effect of each base forecasting model. Such a framework is depicted in FIG. 3. In general, an ensemble model can be fit on observations versus stacked forecasts in different validation blocks. Using such a framework, the temporal order of the data can be preserved, making this framework useful for training time series forecasting models.

A computer system (or e.g., a computing node group, as described further below with reference to FIGS. 6-8) can partition a data set into a number of segments, e.g., n segments. FIG. 3 shows segments 302-306. Each segment can comprise a subsequence of time series data from a time series data set used for training. In some cases, the segments may be of equal length, e.g., each comprise the same number of time series data values, however the segments can also be of unequal lengths. Further, within each segment, the computer system can create k “folds” (also referred to herein as “segment groups”). Each fold can comprise a subsequence of time series data derived from its respective segment. A “rolling window” or “sliding window” segmentation process can be used to produce the folds. Each segment group can be further separated into a sequence of training data (also sometimes referred to as a “training data set” or a “time series training data set”) and a sequence of test data (also sometimes referred to as a “test data set” or a “time series test data set). As depicted in FIG. 3, for segment 1 302, the first segment group (or fold) 308 comprises training data set 314 and test data set 316, the second segment group 310 comprises training data set 318 and test data set 320, and the kth segment group 312 comprises training data set 322 and test data set 324.

In some embodiments, a computer system or user of the computer system can create the folds such that the test data sets are non-overlapping, i.e., such that they do not share any time series data elements corresponding to the same time period or time periods. This can be accomplished by defining the length of the training data sets, test data sets, and fold subsequences, and by defining the stride of the rolling window segmentation process such that the test data sets do not overlap. Some or all of these parameters may be referred to as “configuration variables”, and may be determined or established by a user of the computer system. If the test data sets do not overlap, they can collectively comprise their entire respective segment (or e.g., a significant fraction of their respective segment). As such, by “stacking” (e.g., concatenating) the test data sets corresponding to a particular segment together, in chronological order, a computer system could effectively recreate most or all of the time series data in the segment. By doing this for all segments, the computer system could effectively recreate most or all of the time series data that was originally segmented and separated into folds.

A computer system can train each base forecasting model using the training data sets (e.g., training data sets 314-322) defined for the segments and folds. After performing this training, each base forecasting model can attempt to forecast the time series data corresponding to the test data sets. For example, a base forecasting model could use training data set 314 as an input and generate a forecast data set corresponding to test data set 316. If the test data sets are non-overlapping, then the forecast data sets are also non-overlapping, and the same stacking logic, described above, can be applied. By stacking the forecast data sets corresponding to a particular segment together, in chronological order, a computer system can effectively create a forecast corresponding to most or all of the time series data in that segment. By doing this for all segments, the computer system can effectively create a forecast corresponding to most or all of the time series data that was originally segmented and separated into folds.

This forecasting and stacking process enables evaluation of the accuracy or effect of each base learner, as the stacked time series forecast data for each base learner can be compared against the actual time series data. As such, and as depicted in FIG. 3, a computer system can stack the forecasts and actuals 330-336 corresponding to each segment (e.g., in a stacking step 326) and use this as data 328 to fit (e.g., train) an ensemble machine learning model. The ensemble model can effectively learn the correlations between forecasts produced by each base learner and the actual time series data, in order to determine how to combine the forecasts produced by each base learner into an accurate ensembled forecast. This temporal stacking k-folds cross validation training method is described in more detail below with reference to FIG. 4.

FIG. 4 shows a flowchart of an exemplary method of training a time series forecasting system comprising a plurality of machine learning models (e.g., base learner models) and an ensemble machine learning model. Such a method can be performed by a computer system that instantiates and trains these machine learning models, e.g., as depicted in FIG. 1. At step 402, the computer system can obtain a data set comprising time series data. The data set can comprise any variety of time series data, e.g., time series weather data, time series health data, time series service demand data, etc., as described above. The data set can comprise a sequence of time series data values or observations. As an example, a data set could comprise a sequence of outdoor temperature measurements, e.g., sampled once per hour at a particular weather monitoring station. The data set can also include timestamps, time values, or indices corresponding to the time series data values, which can enable a chronological ordering of the data set. The data set can also include any variety of metadata, e.g., labelling data indicating the source of the time series data. The computer system can obtain the data set from a database or other data store, such as data store 106 depicted in FIG. 1, e.g., by querying such data storage systems. Alternatively, if the computer system is a member of a distributed computing system, the computer system could obtain the data set from a coordinator computer that coordinates the operator of computing nodes in the distributed computing system, e.g., as described in more detail below with reference to FIG. 7.

In some methods according to embodiments, a computer system may use one or more external training features to train the plurality of machine learning models and/or the ensemble machine learning model. As such, at step 402, the computer system may optionally obtain these one or more external training features. Such external training features could comprise, e.g., non-time series data that nevertheless may be useful in time series forecasting. Such external training features could depend on the nature of the time series forecasting being performed. For example, for a weather forecasting service, external training features could include transient geological information, such as data related to a recent volcanic eruption, which may have an impact on global weather patterns.

At step 404, the computer system can partition the data set into a plurality of segments. Each segment can comprise a subsequence of time series data from the data set. In some embodiments, the plurality of segments can comprise a plurality of non-overlapping subsequences of time series data from a sequence of time series data comprising the time series data set. In some embodiments, each segment may be the same length, i.e., comprise the same number of time series data values. Alternatively, the segments may be different lengths, e.g., one segment may be twice as long as another. The variable n, may be used herein to refer to the number of segments in the plurality of segments, e.g., as depicted in FIG. 3. Although embodiments are typically described herein from the perspective of univariate time series for ease of explanation, it should be understood that the data set can comprise multiple univariate time series, a single highly multivariate time series, multiple multivariate time series, etc. In some embodiments, the data set could comprise, e.g., tens of thousands of time series, each of which could be partitioned.

The computer system can use any appropriate means to partition the data set into a plurality of segments. For example, for a time series data set comprising 1000 data values, partitioned into n=10 segments, the computer system could determine the number of data values in each segment, i.e., 1000/10=100 data values, then iterate through the time series data set and collect subsequences comprising 100 data values, e.g., a subsequence comprising data values 1-100, 101-200, 201-300, etc. The computer system can then partition the data set into a plurality of segments using these subsequences.

As an example, in order to train an ensemble monthly average global temperature forecasting model, at step 404, a computer system could partition 200 years of recorded global average temperature data (e.g., obtained at step 404) into 20 segments, each containing 10 consecutive years of recorded weather data, e.g., corresponding to the global average temperature data recorded in each month over that 200 year period.

At step 406, the computer system can create a plurality of segment groups (or folds) for each segment of the plurality of segments, e.g., as depicted in FIG. 3. Each segment group can comprise a time series training data set and a time series test data set. In this way, the computer system can create a plurality of time series training data sets and a plurality of time series test data sets. Each time series training data set can correspond to a training time period and each time series test data set can correspond to a testing time period. In some embodiments, the computer system can create the plurality of segment groups such that each training time period immediately precedes a corresponding testing time period, e.g., as depicted in FIG. 3. Additionally, the computer system can create the plurality of segment groups such that the plurality of time series test data sets (and the corresponding plurality of testing time periods) do not overlap in time, also as depicted in FIG. 3. The computer system can use any appropriate method to create the plurality of segment groups, e.g., using rolling segmentation and sliding windows. “window lengths” and “strides” may be used to define this rolling segmentation or sliding window segmentation process, and may comprise hyperparameters of the training process used to train the ensemble machine learning model.

Continuing the global average temperature forecasting example above, to train an ensemble global average temperature forecasting model, at step 406, the computer system could create a plurality of folds (segment groups) for each of the 20 segments of global average temperature data partitioned at step 404. Each segment group could comprise, e.g., five years of monthly global average temperature data. The first four years of each segment group could comprise the time series training data set, and the fifth year of each segment group could comprise the time series test data set.

As described below, machine learning models could be trained to forecast the fifth year of data (the time series test data set corresponding to a given fold) given the first four years of data (the time series training data set) as an input. The computer system could, for example, create six folds (segment groups) each comprising five consecutive years of monthly global average temperature data for each 10 year segment (years 1-5, 2-6, 3-7, 4-8, 5-9, and 6-10), thereby collectively creating 120 segment groups for all 20 segments partitioned at step 404.

At step 408, the computer system can train each machine learning model of a plurality of machine learning models (e.g. base learner models, as described above) using the plurality of time series training data sets, thereby producing a plurality of trained machine learning models. This plurality of machine learning models can include any applicable time series forecasting models or machine learning model types, which can include, as non-limiting examples, autoregressive (AR) models, moving average (MA) models, autoregressive moving average (ARMA) models, autoregressive integrated moving average (ARIMA) models, seasonal autoregressive integrated moving average (SARIMA) models, autoregressive integrated moving average models with exogenous regressors (ARIMAX), seasonal autoregressive integrated moving average models with exogenous regressors (SARIMAX), ETS models, statsmodels, Prophet models, lightgbm models, and the like. The plurality of machine learning models can be trained to forecast time series data based on historical time series data, and the computer system can use any appropriate training method to train the plurality of machine learning models.

Continuing the global average temperature forecasting example above, the computer system can use the training data sets to train time series forecasting models using the time series training data sets from the segment groups created at step 406. As described above, each time series training data set could comprise four consecutive years of monthly global average temperature data from a ten year segment. Each four consecutive years of global monthly average temperature data could be used to predict global monthly average temperature data for a fifth year. For example, the computer system could train a given time series forecasting model based on training data corresponding to years 1-4 from a particular 10 year segment along with years 2-5, 3-6, 4-7, 5-8, and 6-9. This training process can be performed for all segments and all machine learning model used to produce an ensemble global monthly average temperature forecast.

As stated above, in general terms, each machine learning model can be trained to predict or forecast time series data based on historical time series data provided as an input. For example, in the context of forecasting monthly global average temperature, each machine learning model could use historical monthly global average temperatures to produce a time series that forecasts monthly global average temperature in the future. As described below, these trained models can be used to predict forecasts corresponding to time series test data sets in each segment group. In the context of forecasting global average temperature, this could comprise using the first four years of temperature data in each segment group (e.g., years 1-4 for one segment group, or, e.g., years 2-5 for another segment group) to predict the fifth year of global average temperatures in that segment group, e.g., predicting global average temperatures in year 5 based on global average temperatures in years 1-4, or predicting global average temperatures in year 6 based on global average temperatures in years 2-5. Because the actual global average temperature data for these segment groups (folds) is known (e.g., because it can comprise the time series test data sets), the difference between what each model forecasts or predicts and the actual global average temperature can be used to evaluate the accuracy of each model, or can e.g., be used to train an ensemble model to produce a final global average temperature forecast that combines the forecast of each individual global average temperature model.

At step 410, the computer system can use the plurality of trained machine learning models to determine a plurality of time series forecast data sets that correspond to the plurality of time series test data sets. Expressed in other words, the trained machine learning models can generate forecasts corresponding to the known time series data contained in the time series test data sets, using, e.g., the time series data in the time series training data sets immediately preceding the time series test data sets as input data. If a trained machine learning model is accurate, time series forecast data sets produced using that machine learning model could be similar to any corresponding time series test data sets. As such, a trained machine learning model's accuracy can be evaluated based on the difference between forecasted time series data sets and corresponding time series test data sets.

In some embodiments, each time series forecast data set in the plurality of time series forecast data sets can correspond to a respective time period (e.g., a respective testing time period, as described above with respect to the generation of segment groups). The plurality of time series forecast data sets in each segment may not overlap in time as a result of no two or more of the time series forecast data sets corresponding to overlapping time periods.

In some embodiments, the plurality of time series forecast data sets can comprise a plurality of pluralities of base model forecast data sets. Each plurality of base model forecast data sets can correspond to a different machine learning model of the plurality of machine learning models. Expressed in other terms, each trained machine learning model can create a time series forecast data set for each segment group in each segment, and these time series forecast data sets can collectively comprise the plurality of time series forecast data sets.

Each base model forecast data set can comprise a chronologically ordered sequence of time series forecast data values. Such chronologically ordered sequences of time series forecast data values can each be associated with a sequence of forecast timestamps or a sequence of forecast indices (indicating, e.g., a time or relative time associated with the forecasts). In some embodiments, forecast timestamps or forecast indices can be used by the computer system to stack the plurality of time series forecast data sets, e.g., as described below with reference to step 412.

Continuing the global average temperature forecasting example provided above, for each fold (segment group), each machine learning model can produce a global average temperature forecast corresponding to a time series test data set, based on data from a corresponding time series training data set. For example, for a fold comprising years 1-5 of a 10 year long segment of global average temperature data, each machine learning model could “forecast” the (already known) global average temperature data for year 5 based on the global average temperature data corresponding to years 1-4. Similarly, for a fold comprising years 2-6 of a 10 year long segment of global average temperature data, each machine learning model could forecast global average temperature data for year 6 based on the global average temperature data corresponding to years 2-5, and so on for year 7 (based on years 3-6), year 8 (based on years 4-7), year 9 (based on years 5-8), and year 10 (based on years 6-9). Each trained machine learning model can perform this process on each segment.

As a result, a given machine learning model may produce forecasts corresponding to a fraction (in some cases a significant fraction) of the data contained in the original dataset, e.g., the original 200 years of global average temperature data. For example, in the first ten year segment, for six folds, a given machine learning model can generate global average temperature forecasts corresponding to years 5, 6, 7, 8, 9, and 10, collectively corresponding to a six year long time period of the ten year segment. By modifying the parameters of the segmentation process and the folding or segment group creation process, it is possible to, e.g., increase, the length of this collectively forecast time period, e.g., by increasing the number of folds to nine two yearlong folds (each comprising one year of training data and one year of test data), it would be possible to create forecasts corresponding to a 9 year long period (years 2-9) of the segment. As described below, the computer system can “stack” (e.g., combine), e.g. the global average temperature forecasts to produce a single combined global average temperature forecast for each machine learning model, corresponding to e.g., years 5-200 of the original global average temperature datasets obtained at step 402. As described above, the difference between what each model forecasts (the stacked forecasted global average temperature time series) and the actual global average temperature time series (the original data set) can be used to evaluate the accuracy of each model, or can be used to train an ensemble model to produce a final global average temperature forecast that combines the forecast of each individual global average temperature model.

At step 412, the computer system can stack the plurality of time series forecast data sets according to time for each machine learning model, thereby creating a plurality of stacked time series forecast data sets corresponding to the plurality of machine learning models. As described above, this process is generally depicted in FIG. 3. This stacking process can be accomplished in a variety of ways. As described above, the plurality of time series forecast data sets can comprise a plurality of pluralities of base model forecast data sets and each plurality of base model forecast data sets can correspond to a different machine learning model. Further, each base model forecast data set can comprise a chronologically ordered sequence of time series forecast data values associated with a sequence of forecast timestamps or a sequence of forecast indices. In such a case, the computer system could, for each machine learning model, determine a chronological ordering of base model forecast data sets within a corresponding plurality of base model forecast data sets using e.g., sequences of forecast timestamps or forecast indices. The computer system could then combine the corresponding plurality of base model forecast data sets according to the chronological ordering, thereby stacking the plurality of time series forecast data sets according to time for each machine learning model. In some embodiments, the computer system can combine a plurality of base model forecast data sets by concatenating the plurality of base model forecast data sets together, such that the plurality of base model forecast data sets are in the chronological ordering.

Expressed in more general terms, as described above with reference to FIG. 3, the computer system use each trained machine learning model to create forecasted time series data corresponding to each time series test data set. If the time series test data sets span the length of the entire data set obtained in step 402, then the trained machine learning models can each effectively recreate the entire data set via their forecasts. This can enable the computer system to compare the forecasted time series data to the actual time series data, in order to e.g., evaluate the accuracy of each trained machine learning model for the purpose of training an ensemble machine learning model.

Continuing the global average temperature forecasting example provided above, at step 412, the computer system can stack (combine) shorter segments of time series global average temperature forecasts to create longer segments of time series global average temperature forecasts, and this process can be performed for each machine learning model. For example, if (over all 20 ten year long segments of global average temperature data) five global average temperature forecasting models each produced forecasts corresponding to year 5, year 6, year 7, . . . year 200, at step 412 the computer system could stack those forecasts to create five forecasts (corresponding to each of the five machine learning models) each corresponding to years 5-200. These five forecasts could comprise the plurality of stacked time series forecast data sets corresponding to the plurality of machine learning models described above. As described above, the difference between what each model forecasts or predicts (the stacked forecasted global average temperature time series) and the actual global average temperature time series (the original data set) can be used to evaluate the accuracy of each model, or can be used to train an ensemble model to produce a final global average temperature forecast that combines the forecast of each individual global average temperature model.

At step 414, the computer system can train an ensemble machine learning model to generate a combined forecast. The ensemble machine learning model can be trained using the plurality of stacked time series forecast data sets from the plurality of trained machine learning models (e.g., generated at step 412), in addition to the data set comprising time series data (e.g., obtained at step 402). In some embodiments, the computer system can train the ensemble machine learning model to generate a combined forecast using one or more external training features in addition to the data described above. The computer system can obtain the one or more external training features (e.g., at step 402 as described above, or at any other appropriate time) in order to train the ensemble machine learning model.

In some embodiments, the computer system can train the ensemble machine learning model to generate a combined forecast by determining a set of error terms for each machine learning model of the plurality of machine learning models. Each set of error terms can comprise at least one error term. The computer system can determine each set of error terms by comparing a stacked time series forecast data set corresponding to a machine learning model to an actual time series data set derived from the data set comprising the time series data, which could comprise, e.g., the time series test data sets. In this way the computer system can determine a plurality of sets of error terms. The computer system can then update a parameter set associated with the ensemble machine learning model (e.g., a characterizing parameter set) based on the plurality of sets of error terms in order to train the ensemble machine learning model. The computer system can perform this parameter update process, over numerous training rounds if necessary. It should be understood however, that the computer system can train the ensemble machine learning model using any appropriate training technique, and that the training described above is only one non-limiting example.

The ensemble machine learning model can comprise any type of machine learning model that can be used to ensemble time series forecast data sets produced by the plurality of machine learning models. As some examples, the ensemble machine learning model can comprise a neural network, a linear regression model, a logistic regression model, a transformer model, etc. In some embodiments, the ensemble machine learning model can comprise a combination model. In such cases, the ensemble machine learning model can generate a combined forecast by generating a weighted combination of a plurality of base model forecasts generated by the plurality of trained machine learning models. In such a case, training the ensemble machine learning model can comprise determining a plurality of weights corresponding to the plurality of trained machine learning models, and the weighted combination can be determined by this plurality of weights.

Continuing the global average temperature forecasting example provided above, at step 414, the computer system can train an ensemble global average temperature forecasting model based on the stacked global average temperature forecasts produced by the plurality of global average temperature forecasting models. For example, if there are five global average temperature forecasting models that were used to produce five stacked global average temperature forecasts corresponding to e.g., years 5-200 of the original dataset, the ensemble machine learning model can be trained to combine these five stacked forecasts to produce a combined global average temperature forecast that more accurately reflects that 196 year period of global average temperature data than any individual global average temperature forecast. For example, the ensemble forecasting model could output a weighted average of global average temperature forecasts provided to the ensemble forecasting model as features. This weighted average could be defined by five weights, each corresponding to a respective global average temperature forecasting model. The process of training the ensemble forecasting model could comprise determining five weights that minimize the mean squared error between the global average temperature time series data values from the original global average temperature data set (or, e.g., years 5-200) and the weighted average of the five stacked global average temperature forecasts.

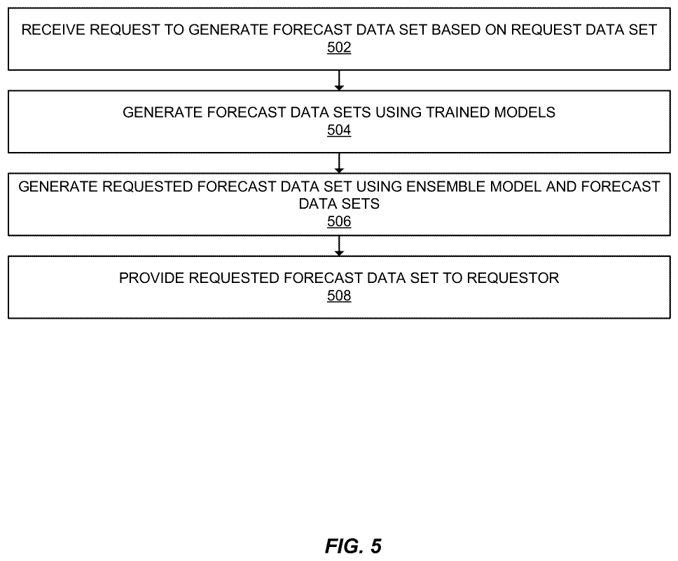

After training the plurality of machine learning models and the ensemble machine learning model, the computer system can use the trained models for some purpose, e.g., generating time series forecasts on behalf of requestors, e.g., as described above with reference to FIG. 1. FIG. 5 depicts a flowchart corresponding to an exemplary method for servicing forecast requests from requestors. At step 502, the computer system can receive a request from a requestor to generate a requested time series forecast data set corresponding to a request data set. The request data set could comprise, e.g., historical time series data, and the requested time series forecast data set could comprise a time series forecast based on that historical time series data. The computer system can receive this request from the requestor, e.g., as a request message transmitted over a network such as the Internet or a local area network, via a direct connection or via any other applicable means.

In some embodiments, the requested time series forecast data set could correspond to forecasted demand for a service, such as an item fulfillment service, e.g., corresponding to the forecasted number of fulfillment requests for that item fulfillment service in the future. Such forecasted demand for the service could be based on historical demand for the service, e.g., as indicated by the request data set. As another example, the requested time series forecast data set could correspond to a forecasted service time corresponding to that service. In the case of an item fulfillment service, this could comprise estimates of the amount of time it may take to complete an item fulfillment request at given times in the future.

In some embodiments, the requested time series forecast data set can comprise a first statistic used to reduce a variance in a second statistic using variance reduction techniques. Such variance reduction techniques can include the control variates method for variance reduction in Monte Carlo methods. Variance reduction techniques can be particularly useful when attempting to detect differences between treatment and control groups. A statistic (e.g., the “second statistic” mentioned above) could be derived from experimental data, and could be presumed to be an unbiased estimator of an unknown parameter of interest. For example, in the context of an item fulfillment service, sampled data corresponding to deliveries could be used to determine a sample mean reduction in delivery time due to a treatment effect (e.g., a new method for communicating with transporters), which could be used as an unbiased estimator of the treatment effect. However, there may be significant variance in the sampled data. It is possible however to construct another unbiased estimator of the parameter of interest (i.e., the treatment effect) that has a lower variance. This can be accomplished by creating another statistic (e.g., the “first statistic” mentioned above) and combining the first statistic with the second statistic to create the reduced variance estimator. In the context of embodiments, a time series forecasting model (e.g., an ELITE forecasting model) could be used to generate a forecast corresponding to experimental data, such as forecasted delivery times corresponding to experimental delivery times. The forecasted delivery times and the experimentally derived delivery times can be combined to make an unbiased estimator of the average delivery time, which has less variance than the experimental delivery times alone, and which may be more useful for evaluating the effect of the treatment on average delivery time.

In some embodiments, the request may include the request data set, e.g., the historical time series data used to generate the requested time series forecast data set. In other embodiments, the computer system may obtain the request data set from, e.g., a data store, database, or other applicable data source. In some embodiments, the computer system may generate the requested time series forecast data set using one or more external features in addition to the request data set. The computer system may likewise obtain these one or more external features from, e.g., the requestor, the data store, or from any other applicable source. The computer system may obtain the request data set and external features during step 502 or at any other appropriate time.

At step 504, the computer system can use the plurality of trained machine learning models and the request data set to determine a plurality of requested time series forecast data sets. The computer system can do so by inputting the request data set (or, e.g., an appropriate subset or subsequence of data values from the request data set) into each of the trained machine learning models, thereby determining a forecast for each trained machine learning model (which can collectively comprise the plurality of requested time series forecast data sets).

At step 506, the computer system can generate the requested time series forecast data set using the ensemble machine learning model and the plurality of requested time series forecast data sets. As depicted in FIG. 2, the computer system can use the plurality of requested time series forecast data sets as features for the ensemble machine learning model and input those features into the ensemble machine learning model, thereby producing the requested time series forecast data set. As described above, in some embodiments, the computer system can generate the requested time series forecast data set using one or more external features in addition to the plurality of requested time series forecast data sets.

At step 508 the computer system can provide the requested time series forecast data to the requestor. The computer system transmit the requested time series forecast data to the requestor, e.g., as a response message over a network such as the Internet or a local area network, via a direct connection or via any other applicable means.

FIGS. 4 and 5 generally relate to methods performed by a computer system for training and using an ensemble time series forecasting model (e.g., an ELITE model) according to embodiments. However, methods according to embodiments can also be performed by distributed computing systems comprising multiple computing nodes. Using distributed computing systems, it is possible to train multiple time series forecasting models in parallel, greatly reducing training time. Some embodiments of the present disclosure can further parallelize the training process by using “nested parallelization” to further improve training speed and efficiency. Using nested parallelization, multiple groups of ensemble machine learning models and multiple base learning models can be trained in parallel to generate forecasts corresponding to different forecasting targets.

FIG. 6 shows a block diagram used to summarize the nested parallelization methods according to embodiments. Generally, computing nodes (or “worker nodes”) in a distributed computing system can be divided into two layers: an ensemble layer 604 (or “outer layer”) corresponding to different ensemble machine learning models and forecasting targets, and a base layer 606 (or “inner layer”) corresponding to individual base learners. In a distributed computing system, training data from data source 602 can be distributed among computing nodes in ensemble layer 604. Computing nodes in this layer (sometimes referred to as “ensemble computing nodes”) can further distribute the task of training individual base learns among computing nodes in the base layer 606, enabling training to be performed in an efficient, highly parallel manner. Without such a parallelization framework, it can be time-consuming and computationally prohibitive to train individual forecasting models (which may number in e.g., the millions) sequentially.

Distributed computing frameworks such as Spark and Ray can be used to implement some forms of nested parallelization. Some methods according to embodiments were implemented using KubeRay to launch Ray clusters on Kubernetes infrastructure. As summarized below with reference to FIGS. 10 and 11, doing so reduced both execution time and computation cost.

Another benefit of the nested parallelization architecture of embodiments of the present disclosure is its generalizability. A standardized implementation framework can enable the integration of models from existing machine learning, deep learning, or forecasting packages, e.g., into base layer 606. Further, some embodiments of the present disclosure allow users to create customized model classes based on their specific needs, enabling those model classes to be integrated into base layer 606. As such, embodiments of the present disclosure have greater flexibility and can be applied to a wide variety of generalizable use cases.

FIG. 7 shows a more depiction of an exemplary distributed computing system 702 according to some embodiments of the present disclosure. The distributed computing system 702 can comprise a coordinator computer 704 and a plurality of computing node groups, e.g., computing node groups 706-710. Each computing node group can comprise multiple computing nodes. For example, computing node group 706 comprises ensemble computing node 712 and base model computing nodes 724 and 726. Collectively, exemplary computing node groups 706-710 can comprise ensemble computing nodes 712-716 and base model computing nodes 724-734. It should be understood that the number of components in FIG. 7 were chosen for ease of explanation, and that a distributed computing system according to embodiments can comprise, e.g., more or less computing node groups, more or less base model computing nodes, etc.

The computing node groups 706-710 can be used by the distributed computing system 702 to implement the nested parallelization framework described above with reference to FIG. 6. The base model computing nodes 724-734 can correspond to the base layer 606 from FIG. 6. Each base model computing node 724-734 can train and use at least one machine learning model (e.g., machine learning models 736-746) to generate time series forecasts. Similarly, the ensemble computing nodes 712-716 can correspond to the ensemble layer 604 from FIG. 6. Each ensemble computing node 712-716 can train and use at least one ensemble machine learning model 718 to ensemble the forecasts produced by the base model computing nodes in its respective computing node group. Using methods according to embodiments, the distributed computing system 702 can not only train machine learning models within a computing node group in parallel, but can also train multiple computing node groups in parallel, greatly accelerating the model training process. Further, nested parallelization can also be used to generate forecasts using trained machine learning models and ensemble machine learning models more quickly and efficiently.

In some embodiments, a coordinator computer 704 can comprise part of the distributed computing system 702. Such a coordinator computer 704 can distribute computing “jobs” or “tasks” among computing nodes and computing node groups in the distributed computing system 702. The coordinator computer 704 can, for example, retrieve time series data 752 from a data source 750 (e.g., a database, a data store, a data stream, etc.), distribute that time series data 752 to computing node groups 706-710, and instruct computing node groups 706-710 to use that time series data to train the machine learning models in those computing node groups (e.g., ensemble machine learning models 718-722 and machine learning models 736-746). In some embodiments, the coordinator computer 704 can also obtain and distribute external training features to computing node groups 706-710, which may be used by computing node groups 706-710 to train their respective machine learning models.

After training, the trained machine learning models can be used for some purpose, e.g., forecasting time series data, e.g., on behalf of one or more requestors such as requestor(s) 748. For example, a requestor 748 could comprise a user who is requesting weather forecasts for an upcoming week. Based on such a request, each computing node group 706-710 could generate a forecast corresponding to a different forecasting target, e.g., computing node group 706 could generate a forecast corresponding to precipitation, computing node group 708 could generate a forecast corresponding to outdoor temperature, and computing node group 710 could generate a forecast corresponding to wind speed.

Requestor(s) 748 may communicate requests to computing node groups in the distributed computing system 702 directly or via the coordinator computer 704. For example, a requestor 748 can comprise a requestor computer system (e.g., a client computer) which may communicate a request to a server coordinator computer 704 over a communication network such as the Internet (not pictured in FIG. 7). The requestor 748 could provide a time series data set used that can be used to generate time series forecasts (along with any relevant external features) to the coordinator computer 704. Alternatively, coordinator computer 704 could identify and obtain any relevant time series data and external features from data source 750 based on the requestor's request. After obtaining this data, the coordinator computer 704 can distribute it to computing node groups 706-710, which can use machine learning models 736-746 and ensemble machine learning models 718-722 to generate requested time series forecast data sets corresponding to a variety of forecasting targets. Each computing node group 706-710 could then return those requested time series forecast data sets to the coordinator computer 704, which could then provide the requested time series forecast data sets to the requestor 748.

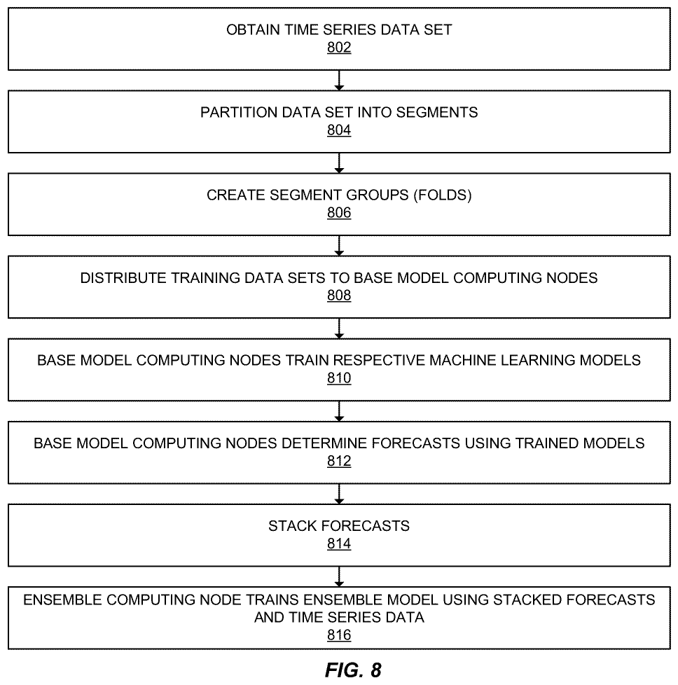

FIG. 8 shows a flowchart of an exemplary method of training a time series forecasting system comprising a plurality of machine learning models (e.g., base learner models) and an ensemble machine learning model. Such a method can be performed by a computing node group comprising an ensemble computing node and a plurality of base model computing nodes, e.g., a computing node group as depicted in FIG. 7. The computing node group may comprise part of a distributed computing system. As such, the flowchart of FIG. 8 corresponds to a parallel computing method for training time series forecasting systems according to embodiments of the present disclosure. As described further below with reference to FIGS. 10 and 11, parallel training methods according to embodiments, when implemented on Spark and Ray computing clusters, resulted in improvements to training speed and reductions to cluster cost.

At step 802, the computing node group can obtain a data set comprising time series data values. As described above with reference to FIG. 4, the data set can comprise a sequence of time series data values or observations, such as a sequence of outdoor temperature measurements, patient blood glucose levels, etc. The data set can also include timestamps, time values, or indices corresponding to the time series data values, which can enable a chronological ordering of the data set. The data set can also include any variety of metadata, e.g., labelling data indicating the source of the time series data. The data set can comprise any variety of time series data, e.g., time series weather data, time series health data, time series demand data, etc., as described above.

The computing node group can obtain the data set from a database or other data store, e.g., a data store such as data source 750 in FIG. 7. In some embodiments, the computing node group may obtain the data set from a coordinator computer (such as coordinator computer 704 from FIG. 7), which may comprise part of a distributed computing system including the computing node group. In some methods according to embodiments, the computing node group may use one or more external training features to train the plurality of machine learning models and/or the ensemble machine learning model. As such, at step 802, the computing node group may optionally obtain these one or more external training features. Such external training features could comprise, e.g., non-time series data that may still be useful in time series forecasting.

The computing node group can obtain the data set in a variety of ways. In some computing node groups, the ensemble computing node may act as a coordinator for other computing nodes (e.g., the plurality of base model computing nodes) in the computing node group. As such, the computing node group may obtain the data set by the ensemble computing node obtaining the data set. As an alternative, each computing node in the computing node group may individually obtain the data set comprising time series data.

As indicated in FIG. 7, in some embodiments a distributed computing system may comprise multiple computing node groups. Each computing node may correspond to a different forecasting target. For example, for a weather forecasting service, one computing node group may produce time series forecasts corresponding to expected rainfall, while another computing node group may produce time series forecasts corresponding to expected outdoor temperature. As another example, for an item fulfillment service, one computing node group may produce time series forecasts corresponding to expected demand, while another computing node group may produce time series forecast corresponding to expected delivery time. As another example, for an item fulfillment service, each forecasting target could correspond to a different region, e.g., different submarkets (e.g., neighborhoods) within a city. For example, one forecasting target (and one computing node group) could correspond to forecasting demand for one submarket, while another forecasting target (and another computing node group) could correspond to forecasting demand for another submarket. Computing node groups corresponding to different forecasting targets can be trained largely independently.

As such, step 802 may be performed for multiple computing node groups in parallel, e.g., the computing node group described above, which may be referred to as a “first computing node group”, and one or more “second computing node groups.” In such a case, the ensemble computing node may be referred to as a “first ensemble computing node” (in order to differentiate it from one or more “second ensemble computing nodes” corresponding to the one or more second computing node groups), and the plurality of base model computing nodes may be referred to as a plurality of “first base model computing nodes” (in order to differentiate them from one or more pluralities of “second base model computing nodes” corresponding to the one or more second computing node groups). Each computing node group may obtain a different data set comprising time series data. As such, the data set described above may be referred to as a “first data set comprising first time series data”, in order to differentiate it from one or more “second data sets comprising second time series data”, which may be obtained by the one or more second computing node groups. However, in some embodiments, the same data may be distributed to each computing node group, i.e., the second time series data can comprise the first time series data. A coordinator computer may distribute the one or more second data sets comprising second time series data to the one or more second computing node groups.

At step 804, the computing node group can partition the data set into a plurality of segments. Each segment can comprise a subsequence of time series data from the data set. In some embodiments, the plurality of segments can comprise a plurality of non-overlapping subsequences of time series data from a sequence of time series data comprising the time series data set. As described above, in some embodiments, each segment may be the same length, however, the segments may also be different lengths. The computing node group can use any appropriate means to partition the data set into a plurality of segments, e.g., by determining a number of data values in each segment, then iterating through the time series data set and collecting subsequences comprising the appropriate number of data values.

The computing node group can partition the data set into a plurality of segments in a variety of ways. For example, the ensemble computing node can partition the data set into a plurality of segments and can later provide those segments or data derived from those segments, e.g., time series training data, to the plurality of base model computing nodes. Alternatively, each base model computing node can partition the data set into a plurality of segments itself, e.g., if those base model computing nodes obtained the data set at step 802.

Again, in some embodiments, a distributed computing system may comprise multiple computing node groups, corresponding to e.g., multiple forecasting targets. As such, step 804 may be performed for multiple computing node groups in parallel, i.e., a first computing node group can partition a first data set comprising first time series data into segments, and each second computing node group can partition a respective second data set comprising second time series data into segments.

At step 806, the computing node group can create a plurality of segment groups (or “folds”) for each segment of the plurality of segments, e.g., as depicted in FIG. 3. Each segment group can comprise a time series training data set and a time series test data set. In this way, the computing node group can create a plurality of time series training data sets and a plurality of time series test data sets. Each time series training data set can correspond to a training time period, and each time series test data set can correspond to a testing time period. In some embodiments, the computing node group can create the plurality of segment groups such that each training time period immediately precedes a corresponding testing time period, e.g., as depicted in FIG. 3. Additionally, the computer system can create the plurality of segment groups such that the plurality of time series test data sets (and the corresponding plurality of testing time periods) do not overlap in time, also as depicted in FIG. 3. The computer system can use any appropriate method to create the plurality of segments groups, e.g., using rolling segmentation and sliding windows. Window lengths and strides may be used to define this rolling segmentation or sliding window segmentation process, and may comprise hyperparameters. The computing node group can create the plurality of segment groups in a variety of ways, e.g., the ensemble computing node can create the plurality of segment groups and later distribute the time series training data sets and the time series test data sets to the base model computing nodes, or alternatively each base model computing node could create the computing node groups independently.

As described above, in some embodiments a distributed computing system can comprise multiple computing node groups. As such, step 806 may be performed by multiple computing node groups in parallel, e.g., a first computing node group can create a first plurality of segment groups for each first segment in a plurality of first segments, and each second computing node group of one or more second computing node groups can each create a second plurality of segment groups for each second segment in a plurality of second segments.

At step 808, the computing node group can distribute the plurality of time series training data sets to the plurality of base model computing nodes. For example, the ensemble computing node, acting as a coordinator for the computing node group, can distribute the plurality of time series training data sets to the plurality of base model computing nodes. However, in some embodiments, the base model computing nodes themselves may have created the plurality of segment groups themselves, and may already possess the plurality of time series training data sets, and hence step 808 may be optional. As described above, for a distributed computing system comprising multiple computing nodes, step 808 may be performed by each computing node, e.g., a first computing node group can distribute a first plurality of time series training data sets to a plurality of first base model computing nodes, and one or more second computing node groups can each distribute second pluralities of time series training data sets to pluralities of second base model computing nodes.

At step 810, each base model computing node can train at least one respective machine learning model of a plurality of machine learning models using the plurality of time series training data sets, thereby (collectively) producing a plurality of trained machine learning models. In some embodiments, each base model computing node may train one respective machine learning model, and in others, some base model computing nodes may train multiple machine learning models, e.g., if the total number of machine learning models in the ensemble time series forecasting system exceeds the number of base model computing nodes.

As described above, the plurality of machine learning models can include any applicable time series forecasting models, which can include, as non-limiting examples, autoregressive (AR) models, moving average (MA) models, autoregressive moving average (ARMA) models, autoregressive integrated moving average (ARIMA) models, seasonal autoregressive integrated moving average (SARIMA) models, autoregressive integrated moving average models with exogenous regressors (ARIMAX), seasonal autoregressive integrated moving average models with exogenous regressors (SARIMAX), ETS model, statsmodels, Prophet, lightgbm, and the like. The plurality of machine learning models can be trained to forecast time series data based on historical time series data, and each base model node can use any appropriate training method to train the plurality of machine learning models.

As described above, in some embodiments a distributed computing system may comprise multiple computing node groups (e.g., a first computing node group and one or more second computing node groups). As such, these computing node groups may perform step 810 in parallel, e.g., a plurality of first base model computing nodes in the first computing node group may train a plurality of first machine learning models, while the one or more second computing node groups each train a respective plurality of second machine learning models using a respective plurality of second base model computing nodes.

At step 812, each base model computing node can use at least one respective trained machine learning model to determine a plurality of time series forecast data sets that correspond to a respective plurality of time series test data sets. Expressed in other words, each base model computing node can use its trained machine learning model(s) to generate forecasts corresponding to the known time series data contained in the time series test data sets, using, e.g., the time series data in the time series training data sets immediately preceding the time series test data sets as input data. Trained machine learning models accuracy can be evaluated based on the difference between forecasted time series data sets and corresponding time series data sets, and the forecasted time series data and actual time series data can be used by ensemble computing nodes to train ensemble machine learning models.

In some embodiments, each time series forecast data set in the plurality of time series forecast data sets can correspond to a respective time period (e.g., a respective testing time period, as described above with respect to the generation of segment groups). The plurality of time series forecast data sets in each segments may not overlap in time as a result of no two or more of the time series forecast data sets corresponding to overlapping time periods.

The plurality of time series forecast data sets can comprise a plurality of pluralities of base model forecast data sets. Each plurality of base model forecast data sets can correspond to a different machine learning model of the plurality of machine learning models. Expressed in other terms, each trained machine learning model can create a time series forecast data set for each segment group in each segment, and these time series forecast data sets can collectively comprise the plurality of time series forecast data sets.

Each base model forecast data set can comprise a chronologically ordered sequence of time series forecast data values. Such chronologically ordered sequences of time series forecast data values can each be associated with a sequence of forecasting timestamps or a sequence of forecasting indices (indicating, e.g., a time or relative time associated with the forecasts). Such forecast timestamps or forecast indices can be used by the computing node group to stack the plurality of time series forecast data sets, e.g., as described below with reference to step 814.

As described above, a distributing computing system may comprise a first computing node group and one or more second computing node groups. As such, the first computing node group and the one or more second computing node groups may perform step 812 in parallel, e.g., each first base model computing node of a first computing node group can use at least one respective first trained machine learning model to determine a plurality of first time series forecast data sets that correspond to a respective plurality of first time series test data sets, and each second base model computing node of one or more second computing node groups can each use at least one respective second trained machine learning model to determine a plurality of second time series forecast data sets that correspond to a respective plurality of second time series test data sets. Notably, this process can be performed in parallel both within computing node groups and across computing node groups, and this nested parallelization can result in significantly reduced ensemble model training times.

At step 814, the computing node group can stack a respective plurality of time series forecast data sets for each trained machine learning model according to time, thereby creating a plurality of stacked time series forecast data sets corresponding to the plurality of trained machine learning models. As described above, this process is generally depicted in FIG. 3. This stacking process can be accomplished in a variety of ways. For example, each base model computing node can stack its own respective plurality of time series forecast data sets corresponding to its machine learning model, or alternatively the ensemble computing node can perform the stacking. As described above, in some embodiments, the plurality of time series forecast data sets can comprise a plurality of pluralities of base model forecast data sets, and each plurality of base model forecast data sets can correspond to a different machine learning model. Further each base model forecast data set can comprise a chronologically ordered sequence of time series forecast data values associated with a sequence of forecast timestamps or a sequence of forecast indices. In such a case, the computing node group (or e.g., the ensemble computing node or the plurality of base model computing nodes) could, for each machine learning model, determine a chronological ordering of base model forecast data sets within a corresponding plurality of base model forecast data sets using, e.g., sequences of forecast timestamps or forecast indices. The computing node group (or, e.g., particular computing nodes within the computing node group) could then combine the corresponding plurality of base model forecast data sets according to the chronological ordering, thereby stacking the plurality of time series forecast data sets according to time for each machine learning model. In some embodiments, the computing node group can combine a plurality of base model forecast data sets by concatenating the plurality of base model forecast data sets together, such that the plurality of base model forecast data sets are in the chronological ordering.

Expressed in more general terms, as described above with reference to FIG. 3, the computing node group can create, using each trained machine learning model, forecasted timeseries data corresponding to each time series test data set. If the time series test data sets span the length of the entire data set obtained in step 802, then the trained machine learning models can each effectively recreate the entire data set via their forecasts. This can enable the computing node group (or e.g., the ensemble computing node) to compare the forecasted time series data to the actual time series data, in order to e.g., evaluate the accuracy of each trained machine learning model for the purpose of training an ensemble model, as described further below.

As described above, in some embodiments, a distributed computing system can comprise multiple computing node groups, e.g., a first computing node group and one or more second computing node groups. In such embodiments, the computing node groups can perform step 814 in parallel, e.g., the first computing node group can stack a respective plurality of first time series forecast data sets for each first trained machine learning model according to time, thereby creating a plurality of first stacked time series data sets corresponding to the plurality of first trained machine learning models, and each second computing node group can stack a respective plurality of second time series forecast data sets for each second trained machine learning model according to time, thereby creating a plurality of second stacked time series data sets corresponding to the plurality of second trained machine learning models.

At step 816, the ensemble computing node can train an ensemble machine learning model to generate a combined forecast. The ensemble machine learning model can be trained using the plurality of stacked time series forecast data sets from the plurality of trained machine learning models (e.g., generated at step 814) in addition to the time series data. In some embodiments, the ensemble computing node can train the ensemble machine learning model to generate a combined forecast using one or more external training features in addition to the data described above. The computing node group can obtain the one or more external training features (e.g., at step 802 as described above, or at any other appropriate time) in order to train the ensemble machine learning model.

In some embodiments, the ensemble computing node can train the ensemble machine learning model to generate a combined forecast by determining a set of error terms for each machine learning model of the plurality of machine learning models. Each set of error terms can comprise at least one error term. The ensemble computing node can determine each set of error terms by comparing a stacked time series forecast data set corresponding to a machine learning model to an actual time series data set derived from the time series data, which could comprise, e.g., the time series test data sets. In this way, the ensemble computing node can determine a plurality of sets of error terms. The ensemble computing node can then update a parameter set associated with the ensemble machine learning model (e.g., a characterizing parameter set) based on the plurality of sets of error terms in order to train the ensemble machine learning model. The ensemble computing node can repeatedly perform this parameter update process, over numerous training rounds if necessary. It should be understood however, that the ensemble computing node can train the ensemble machine learning model using any appropriate training technique, and the training described above is only one non-limiting example.

As described above, the ensemble machine learning model can comprise any type of machine learning model that can be used to ensemble time series forecast data sets produced by the plurality of machine learning models. As some examples, the ensemble machine learning model can comprise a neural network, a linear regression model, a logistic regression model, a transformer model, etc. In some embodiments, the ensemble machine learning model can comprise a combination model. In such cases, the ensemble machine learning model can generate a combined forecast by generating a weighted combination of a plurality of base model forecasts generated by the plurality of trained machine learning models. In such a case, training the ensemble machine learning model can comprise determining as plurality of weights corresponding to the plurality of trained machine learning models, and the weighted combination can be determined by this plurality of weights.

As described above, in some embodiments a distributed computing system may comprise multiple computing node groups, e.g., a first computing node group and one or more second computing node groups. As such, step 816 can be performed by these computing node groups in parallel, e.g., a first ensemble computing node can train a first ensemble machine learning model to generate a first combined forecast using a plurality of first stacked time series forecast data sets from the plurality of first trained machine learning models, and one or more second ensemble computing nodes can each train a respective second ensemble machine learning model to generate a respective second combined forecast, thereby training the one or more second ensemble machine learning models to generate one or more second combined forecasts. As described above, each computing node group may correspond to a different forecasting target, e.g., the first computing node group may correspond to a first forecasting target, and the one or more second computing node groups (and the one or more second combined forecasts) may correspond to one or more second forecasting targets.

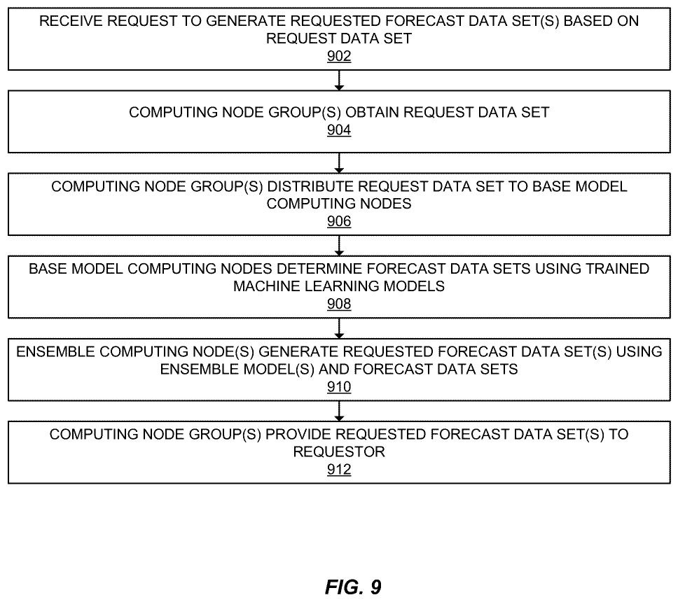

After training the plurality of machine learning models and the ensemble machine learning model, the computing node group (or, e.g., a distributing computing system comprising multiple computing node groups) can use the trained models for some purpose, e.g., generating time series forecasts on behalf of requestors, e.g., as described above with reference to FIG. 1. FIG. 9 depicts a flowchart corresponding to an exemplary method for servicing forecast requests from requestors.

At step 902, a computing node group can receive a request from a requestor to generate a requested time series forecast data set corresponding to a request data set. The request data set could comprise, e.g., historical time series data, and the requested time series forecast data set could comprise a time series forecast based on that historical time series data. The computing node group can receive this request directly from the requestor, e.g., as a request message transmitted over a network such as the Internet or a local area network, via a direct connection or via any other applicable means. The computing node group may receive the request from the requestor, e.g., by one computing node (e.g., the ensemble computing node) receiving the request, or by all some or all computing nodes in the computing node group receiving the request.

In some embodiments, the computing node group may be part of a distributed computing system, which may additionally comprise a coordinator computer. In such cases, the coordinator computer, instead of the computing node group may receive the request from the requestor. In such cases, the coordinator computer could e.g., forward the request to the computing node group.

As describe above, such a distributed computing system could comprise multiple computing node groups, e.g., a first computing node group and one or more second computing node groups. Each computing node group could correspond to a different forecasting target, e.g., for a time series weather forecasting system, one computing node group could correspond to a precipitation forecast, while another computing node group could correspond to an outdoor temperature forecast. In such cases, at step 902, the coordinator computer can receive a request from a requestor to generate a first requested time series forecast data set corresponding to a request data set and a first forecasting target, and one or more second requested time series forecast data sets corresponding to the request data set and one or more second forecasting targets. As described below, the coordinator computer can acquire and distribute the request data set to the computing node groups (e.g., the first computing node group and the one or more second computing node groups), enabling the computing node groups to generate the first requested time series forecast data set and the one or more second requested time series forecast data sets.

As described above, in some embodiments the requested time series forecast data set (or, e.g., the first requested time series forecast data set and the one or more second requested time series forecast data sets) can correspond to forecasted demand for a service, such as an item fulfillment service. Also as described above, in some embodiments the requested time series forecast data set can comprise a first statistic used to reduce a variance in a second statistic using variance reduction techniques, e.g., the control variates method for variance reduction in Monte Carlo methods.

At step 904, the computing node group (and e.g., any other computing node groups, such as one or more second computing node groups) can obtain the request data set. In some embodiments, the request received at step 902 may include the request data set, e.g., the historical time series data used to generate the requested time series forecast data set. In other embodiments, the computing node group may obtain the request data set from a data store, data base, or other applicable data source. In other embodiments, a coordinator computer may obtain the request data set (e.g., from the requestor) and may distribute the request data set to the computing node group, or e.g., to a plurality of computing node groups, e.g., a first computing node group and one or more second computing node groups. As described above, in some embodiments, computing node groups may generate the requested time series forecast data sets using one or more external features in addition to the request data set. The computing node groups may likewise obtain these one or more external features, e.g., from the requestor, a coordinator computer, a data store or from any other applicable source.

At step 906, each computing node group (e.g., a single computing node group or a plurality of computing node groups comprising a first computing node group and one or more second computing node groups) can distribute the request data set to a plurality of base model computing nodes. For example, a first ensemble computing node from a first computing node group can distribute the request data set to a plurality of first base model computing nodes, and each second ensemble computing node from one or more second computing node groups can distribute the request data set to a respective plurality of second base model computing nodes.

Using the request data set, each computing node group can generate respective requested time series forecast data using a respective plurality of trained machine learning models and an ensemble machine learning model, e.g., as described in more detail below with reference to steps 908 and 910. For example, a first computing node group can generate first requested time series forecast data (e.g., corresponding to a first forecasting target) using a plurality of first trained machine learning models and a first ensemble machine learning model, and likewise, each second computing node group of one or more second computing node groups can generate a respective second requested time series forecast data set using a respective plurality of second trained machine learning models and a respective second ensemble machine learning models. In this way, the one or more second computing node groups can generate one or more second requested time series forecast data sets.

At step 908, each base model computing node of each computing node group (e.g., a plurality of first base model computing nodes from a first computing node group and one or more pluralities of second base model computing nodes from one or more second computing node groups) can generate a respective requested time series forecast data set. Each base model computing node can do so by inputting the request data set (or, e.g., an appropriate subset or subsequence of data values from the request data set) into each trained machine learning model, thereby determining a forecast for each trained machine learning model.

At step 910, each ensemble computing node (e.g., a first ensemble computing node corresponding to a first computing node group and one or more second ensemble computing nodes corresponding to one or more second computing node groups) can generate a requested time series forecast data set using a respective ensemble machine learning model (e.g., a first ensemble machine learning model and one or more second ensemble machine learning models) and the plurality of time series forecast data sets produced by their respective pluralities of base model computing nodes (e.g., a plurality of first base model computing nodes corresponding to the first computing node group and one or more pluralities of second base model computing nodes corresponding to one or more second computing node groups).

As depicted in FIG. 2, each ensemble computing node can use a plurality of requested time series forecast data sets as features for its respective ensemble machine learning model and input those features into its respective ensemble machine learning model, thereby producing a respective requested time series forecast data set (e.g., a first requested time series forecast data set generated by a first computing node group and one or more second requested time series forecast data sets generated by one or more second computing node groups). In some embodiments, each computing node group can generate the requested time series forecast data set using one or more external features in addition to any respective pluralities of requested time series forecast data sets.

At step 912, the computing node groups can provide any requested time series forecast data sets (e.g., the first requested time series data set produced by a first computing node group and one or more second requested time series forecast data sets produced by one or more second computing node groups). In some embodiments, each computing node group can provide its respective requested time series forecast data set to a coordinator computer, and the coordinator computer can provide the requested time series forecast data sets to the requestor (e.g., the first requested time series forecast data set and the one or more second requested time series forecast data sets). The computing node groups and/or the coordinator computer can transmit the requested time series forecast data sets to the requestor, e.g., as a response message over a network such as the Internet or a local area network, via a direct connection, or via any other applicable means.

Some experiments were performed that demonstrate the efficiency and speed of time series forecasting methods, models, and systems according to embodiments. The results of these experiments are summarized in Table 1 and Table 2 of FIGS. 10 and 11 respectively. In one experiment, ensemble time series forecasting models (e.g., ELITE models) according to embodiments of the present disclosure were implemented using a Spark distributed computing framework and a Ray distributed computing framework. These forecasting models were used to generate weekly time series order volume forecasts for several thousand submarkets (e.g., neighborhoods or other geographic subdivisions of towns or cities) for an item fulfillment service. For each submarket, thousands of different model and configuration combinations were explored for the base machine learning models used to generate the forecasts. In these experiments, embodiments of the present disclosure (i.e., the ELITE forecasting system) outperformed grid search in terms of efficiency and accuracy, as shown in Table 1 of FIG. 10.

Summarizing the results of the experiments, for an instance of an ensemble time series forecasting model according to embodiments implemented on a Spark cluster, there was approximately an 83% reduction in execution time and a 96% reduction in cluster cost, as well as a 12% improvement in accuracy in terms of mean absolute percentage error (MAPE). For an instance of an ensemble time series forecasting model according to embodiments implemented on a Ray cluster, there was approximately a 78% reduction in execution time and a 95% reduction in cluster cost, with a 12% improvement in accuracy in terms of MAPE. The results of Table 1 compare ensemble methods according to embodiments versus grid search operating on the same cluster type. However, the use of a Ray cluster further reduces execution time and cluster cost relative to the use of a Spark cluster, as shown in Table 2 of FIG. 11.

Table 2 shows an execution time improvement of 50% using Ray over Spark, as well as a 93% cluster cost reduction using Ray over Spark, indicating that some methods according to embodiments are faster and more efficient using Ray architecture. This is particularly useful for the use case of experimentation variance reduction. For highly granular forecasts, using the ELITE model along with Ray infrastructure lead to further efficiency improvements. The low computational burden achieved by the ELITE model enables it to be executed on small and relatively computationally inexpensive Ray clusters. As a result, in addition to achieving performance improvements relative to grid search, embodiments further improve performance (e.g., by reducing execution time and computation cost) by switching to Ray from Spark clusters.

Some general comments and observations relating to the development and implementation of the ELITE forecasting system and associated methods, models, and systems according to embodiments of the present disclosure are provided below. It is observed that backend infrastructure can have a noticeable impact on the efficiency, speed, cost, and reliability of machine learning solutions. In some cases, non-informative logs for computing clusters (e.g., Spark clusters) can lead to debugging difficulties, which ultimately can slow the implementation of ensemble models such as ELITE. Further, techniques such as constant refractoring can result in significant efficiency gains, and can comprise a good programming practice, e.g., when developing code or systems that includes complex parallelization structures. Techniques such as passing an entire self-class object to many parallelization methods can result in unacceptable slowdowns in data distributions and executions. However, after refractoring to minimize the data and objects passing through these parallelized methods, forecasting efficiency can improve by a relatively large factor, e.g., a factor of six or more.

Embodiments of the present disclosure are applicable not only to the exemplary forecasting problems described herein (e.g., forecasting weather, forecasting demand for an item fulfillment service, forecasting demand for electrical power, etc.), but can also be applied to other forecasting systems that require a heavy model selection process. Embodiments can also serve as a machine learning system where time series forecasting features (such as weather) could be included in addition to stacked model predictions. By establishing ensemble connections between base models, the proposed framework offers the flexibility to support both machine learning and forecasting use cases, resulting in improved accuracy and efficiency benefits, without the need for complex deep learning pipelines.

Any of the computer systems mentioned herein may utilize any suitable number of subsystems. Examples of such subsystems are shown in FIG. 13 in computer system 1300. In some embodiments, a computer system can include a single computer apparatus, where the subsystems can be the components of the computer apparatus. In other embodiments, a computer system can include multiple computer apparatuses, each being a subsystem with internal components. A computer system can include server computers, desktop and laptop computers, tablets, mobile phones and other mobile devices.

The subsystems shown in FIG. 13 are interconnected via a system bus 1312. Additional subsystems such as a printer 1308, keyboard 1318, storage device(s) 1320, monitor 1324 (e.g., a display screen, such as an LED), which is coupled to display adapter 1314, and others are shown. Peripherals and input/output (I/O) devices, which couple to I/O controller 1302, can be connected to the computer system by any number of means known in the art such as input/output (I/O) port 1316 (e.g., USB, FireWire®). For example, I/O port 1316 or external interface 1322 (e.g. Ethernet, Wi-Fi, etc.) can be used to connect computer system 1300 to a wide area network such as the Internet, a mouse input device, or a scanner. The interconnection via system bus 1312 allows the central processor 1306 to communicate with each subsystem and to control the execution of a plurality of instructions from system memory 1304 or the storage device(s) 1320 (e.g., a fixed disk, such as a hard drive, or optical disk), as well as the exchange of information between subsystems. The system memory 1304 and/or the storage device(s) 1320 may embody a computer readable medium. Such a computer readable medium can store or otherwise comprise code or instructions, executable by central processor 1306 to implement some of the methods described herein. Another subsystem is a data collection device 1310, such as a camera, microphone, accelerometer, and the like. Any of the data mentioned herein can be output from one component to another component and can be output to the user.

A computer system can include a plurality of the same components or subsystems, e.g., connected together by external interface 1322, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

What is claimed is:

1. A method comprising:
obtaining, by a computer system, a data set comprising time series data;
partitioning, by the computer system, the data set into a plurality of segments;
for each segment of the plurality of segments, creating, by the computer system, a plurality of segment groups, each segment group comprising a time series training data set and a time series test data set, thereby producing a plurality of time series training data sets and a plurality of time series test data sets;
training, by the computer system, each machine learning model of a plurality of machine learning models using the plurality of time series training data sets, thereby producing a plurality of trained machine learning models;
determining, by the computer system, using the plurality of trained machine learning models, a plurality of time series forecast data sets that correspond to the plurality of time series test data sets;
stacking, by the computer system, the plurality of time series forecast data sets according to time for each machine learning model, thereby creating a plurality of stacked time series forecast data sets corresponding to the plurality of machine learning models; and
training, by the computer system, an ensemble machine learning model to generate a combined forecast using the plurality of stacked time series forecast data sets from the plurality of trained machine learning models and the data set comprising time series data.

2. The method of claim 1, wherein the data set comprises a sequence of time series data, wherein the plurality of segments comprise a plurality of non-overlapping subsequences of time series data from the sequence of time series data, and wherein the plurality of time series training data sets and the plurality of time series test data sets comprise a plurality of subsequences of time series data from the plurality of non-overlapping subsequences of time series data.

3. The method of claim 1, wherein training, by the computer system, the ensemble machine learning model to generate a combined forecast using the plurality of stacked time series forecast data sets from the plurality of trained machine learning models and the data set comprising the time series data comprises:
determining, by the computer system, for each trained machine learning model, a set of error terms comprising at least one error term by comparing a stacked time series forecast data set corresponding to that machine learning model to an actual time series data set derived from the data set comprising the time series data, thereby determining a plurality of sets of error terms; and
updating a parameter set associated with the ensemble machine learning model based on the plurality of sets of error terms.

4. The method of claim 1, wherein the ensemble machine learning model comprises a neural network, a linear regression model, or a logistic regression model.

5. The method of claim 1, wherein the ensemble machine learning model comprises a combination model, wherein the ensemble machine learning model generates a combined forecast by generating a weighted combination of a plurality of base model forecast generated by the plurality of trained machine learning models, and wherein training the ensemble machine learning model comprises determining a plurality of weights corresponding to the plurality of trained machine learning models, the weighted combination determined, in part, by the plurality of weights.

6. The method of claim 1, wherein each time series training data set corresponds to a training time period, wherein each time series test data set corresponds to a testing time period, and wherein the computer system creates the plurality of segment groups, such that each training time period immediately precedes a corresponding testing time period.

7. The method of claim 1, wherein each time series forecast data set of the plurality of time series forecast data sets correspond to a respective time period, and wherein the plurality of time series forecast data sets in each segment do not overlap in time as a result of no two or more of the time series forecast data sets corresponding to overlapping time periods.

8. The method of claim 1, wherein the plurality of machine learning models correspond to one or more machine learning model types, wherein the one or more machine learning model types include one or more of:
autoregressive (AR) models;
moving average (MA) models;
autoregressive moving average (ARMA) models;
autoregressive integrated moving average (ARIMA) models;
seasonal autoregressive integrated moving average (SARIMA) models;
autoregressive integrated moving average models with exogenous regressors (ARIMAX);
seasonal autoregressive integrated moving average models with exogenous regressors (SARIMAX); and
ETS models.

9. The method of claim 1, wherein the plurality of time series forecast data sets comprise a plurality of pluralities of base model forecast data sets, each plurality of base model forecast data sets corresponding to a different machine learning model of the plurality of machine learning models, wherein each base model forecast data set comprises a chronologically ordered sequence of time series forecast data values associated with a sequence of forecast timestamps or a sequence of forecast indices, and wherein stacking the plurality of time series forecast data sets according to time for each machine learning model comprises:
determining, by the computer system, for a corresponding plurality of base model forecast data sets, a chronological ordering of base model forecast data sets within that plurality of base model forecast data sets; and
combining, by the computer system, the corresponding plurality of base model forecast data sets according to the chronological ordering, thereby stacking the plurality of time series forecast data sets according to time for each machine learning model.

10. The method of claim 9, wherein combining the corresponding plurality of base model forecast data sets comprises:
concatenating the corresponding plurality of base model forecast data sets together such that the plurality of base model forecast data sets are in the chronological ordering.

11. The method of claim 1, the method further comprising:
receiving, by the computer system, a request from a requestor to generate a requested time series forecast data set corresponding to a request data set;
obtaining, by the computer system, the request data set;
determining, by the computer system, using the plurality of trained machine learning models and the request data set, a plurality of requested time series forecast data sets;
generating, by the computer system, the requested time series forecast data set using the ensemble machine learning model and the plurality of requested time series forecast data sets; and
providing, by the computer system, to the requestor, the requested time series forecast data set.

12. The method of claim 11, wherein the computer system trains the ensemble machine learning model to generate a combined forecast using one or more external training features in addition to the plurality of stacked time series forecast data sets and the data set comprising time series data, wherein the computer system generates the requested time series forecast data set using the ensemble machine learning model using one or more external features in addition to the plurality of requested time series forecast data sets, and wherein the method further comprises:
obtaining the one or more external training features; and
obtaining the one or more external features.

13. The method of claim 11, wherein the requested time series forecast data set corresponds to forecasted demand for a service or corresponds to a forecasted service time corresponding to that service, or wherein the requested time series forecast data set comprises a first statistic used to reduce a variance in a second statistic using variance reduction techniques.

14. A method performed by a computing node group comprising an ensemble computing node and a plurality of base model computing nodes, the method comprising:
obtaining, by the computing node group, a data set comprising time series data;
partitioning, by the computing node group, the data set into a plurality of segments;
for each segment in the plurality of segments, creating, by the computing node group, a plurality of segment groups, each segment group comprising a time series training data set and a time series test data set, thereby producing a plurality of time series training data sets and a plurality of time series test data sets;
distributing, by the computing node group, the plurality of time series training data sets to the plurality of base model computing nodes;
training, by each base model computing node, at least one respective machine learning model of a plurality of machine learning models using the plurality of time series training data sets, thereby producing a plurality of trained machine learning models corresponding to the plurality of base model computing nodes;
determining, by each base model computing node, using at least one respective trained machine learning model, a plurality of time series forecast data sets that correspond to a respective plurality of time series test data sets;
stacking according to time, by the computing node group, a respective plurality of time series forecast data sets for each trained machine learning model, thereby creating a plurality of stacked time series forecast data sets corresponding to the plurality of trained machine learning models; and
training, by the ensemble computing node, an ensemble machine learning model to generate a combined forecast, the ensemble machine learning model trained using the plurality of stacked time series forecast data sets and the time series data.

15. The method of claim 14, further comprising:
receiving, by the computing node group, a request from a requestor to generate a requested time series forecast data set corresponding to a request data set;
obtaining, by the computing node group, the request data set;
distributing, by the computing node group, the request data set to the plurality of base model computing nodes;
determining, by each base model computing node, using the at least one respective trained machine learning model, a respective time series forecast data set, thereby generating a plurality of requested time series forecast data sets;
generating, by the ensemble computing node, the requested time series forecast data set using the ensemble machine learning model and the plurality of requested time series forecast data sets; and
providing, by the computing node group, to the requestor, the requested time series forecast data set.

16. The method of claim 14, wherein the computing node group obtains the data set comprising time series data from a coordinator computer, wherein a distributed computing system comprises the coordinator computer and the computing node group.

17. The method of claim 16, wherein:
the data set comprising time series data comprises a first data set comprising first time series data;
the computing node group comprises a first computing node group;
the ensemble computing node comprises a first ensemble computing node;
the plurality of base model computing nodes comprises a plurality of first base model computing nodes;
the plurality of machine learning models comprise a plurality of first machine learning models;
the plurality of trained machine learning models comprise a plurality of first trained machine learning models;
the ensemble machine learning model comprises a first ensemble machine learning model;
the combined forecast comprises a first combined forecast;
the first combined forecast corresponds to a first forecasting target;
the distributed computing system comprises one or more second computing node groups;
each second computing node group of the one or more second computing node groups comprises a second ensemble computing node and a plurality of second base model computing nodes;
the coordinator computer distributes one or more second data sets comprising second time series data to the one or more second computing node groups;
the one or more second computing node groups each train a respective plurality of second machine learning models using a respective plurality of second base model computing nodes;
the one or more second computing node groups each train a respective second ensemble machine learning model to generate a respective second combined forecast using a respective second ensemble computing node, the one or more second computing node groups thereby training one or more second ensemble machine learning models to generate one or more second combined forecasts; and
the one or more second combined forecasts correspond to one or more second forecasting targets.

18. The method of claim 17, wherein the second time series data comprises the first time series data.

19. The method of claim 17, further comprising:
receiving, by the coordinator computer, a request from a requestor to generate a first requested time series forecast data set corresponding to a request data set and the first forecasting target, and one or more second requested time series forecast data sets corresponding to the request data set and one or more second forecasting targets;
obtaining, by the coordinator computer, the request data set;
distributing, by the coordinator computer, the request data set to the first computing node group and the one or more second computing node groups;
distributing, by the first ensemble computing node, the request data set to the plurality of first base model computing nodes;
distributing, by each second ensemble computing node of the one or more second computing node groups, the request data set to each respective plurality of second base model computing nodes;
generating, by the first computing node group, the first requested time series forecast data using the plurality of first trained machine learning models and the first ensemble machine learning model;
generating, by each second computing node group of the one or more second computing node groups, a respective second requested time series forecast data set using a respective plurality of second trained machine learning models and a respective second ensemble machine learning model, thereby generating the one or more second requested time series forecast data sets; and
providing, by the coordinator computer, to the requestor, the first requested time series forecast data set and the one or more second requested time series forecast data sets.

20. A computer system comprising:
a processor; and
a non-transitory computer readable medium coupled to the processor, the non-transitory computer readable medium comprising code, executable by the processor for performing a method comprising:
obtaining a data set comprising time series data;
partitioning the data set into a plurality of segments;
for each segment of the plurality of segments, creating a plurality of segment groups, each segment group comprising a time series training data set and a time series test data set, thereby producing a plurality of time series training data sets and a plurality of time series test data sets;
training each machine learning model of a plurality of machine learning models using the plurality of time series training data sets, thereby producing a plurality of trained machine learning models;
determining, using the plurality of trained machine learning models, a plurality of time series forecast data sets that correspond to the plurality of time series test data sets;
stacking the plurality of time series forecast data sets according to time for each machine learning model, thereby creating a plurality of stacked time series forecast data sets corresponding to the plurality of machine learning models; and
training an ensemble machine learning model to generate a combined forecast using the plurality of stacked time series forecast data sets from the plurality of trained machine learning models and the data set comprising time series data
